(19) United States
(12) Patent Application Publication
(10) Pub. No.: US 2012/0130856 A1
(43) Pub. Date: May 24, 2012

(54) Modularized In Application Commerce System and Method

(75) Inventors: Daniel Petri, Vienna (AT); Georg Kohout, Vienna (AT); Georg Nader, Vienna (AT); Martin Mayerhofer, Vienna (AT)

(73) Assignee: DIGITAL RIVER, INC., Minnetonka, MN (US)

(21) Appl. No.: 13/304,171

(22) Filed: Nov. 23, 2011

Related U.S. Application Data
(60) Provisional application No. 61/417,083, filed on Nov. 24, 2010.

(51) Int. Cl. G06Q 30/06

(52) U.S. Cl. 705/26.61

(57) ABSTRACT

An in-game e-commerce web service system and method is described. The system provides a seamlessly integrated, modular, turn-key solution to in-game commerce on game publisher web sites. Primary publisher-to-player and secondary player-to-player markets are supported along with their associated billing and customer management functions. Modules have been designed to allow the greatest flexibility in choosing the services to which a game publisher subscribes.

### RELATED APPLICATIONS

This application claims the benefit of U.S. Provisional Application No. 61/417,083 filed 24 Nov. 2010, entitled “Modularized In-Application E-Commerce System and Method”, which is incorporated herein by reference.

This patent application is related to co-pending U.S. patent application Ser. No. ______, filed 23 Nov. 2011, and entitled “In-Application Commerce System and Method with Fraud Detection” which claims the benefit of U.S. Provisional Application No. 61/417,063 which was filed 24 Nov. 2010, entitled “In-Application Commerce System and Method,” all of which are incorporated herein by reference.

### FIELD OF THE INVENTION

The present disclosure relates to commerce systems for use in the internet gaming industry. More particularly, the present disclosure relates to a modular in-game e-commerce system and method for providing shopping, auction and subscription services to online game players.

### BACKGROUND OF THE INVENTION

According to Strategy Analytics, a leading digital-industry research and consulting firm, the global online gaming market was worth $4 billion in 2007, and is expected to triple that number by 2011. The online games market is currently the largest category of online, revenue-producing entertainment, particularly the Massively Multiplayer Online Games (MMOG) and Massively Multiplayer Online Role-Playing Games (MMORPG) segments. These games are highly interactive, collaborative and commercial. They also offer new opportunities for marketing content and products and for integrating e-commerce.

The buying experience in an in-game e-commerce ecosystem should be as seamless and as simple as possible. While the player should be aware of his/her purchasing capabilities at all times, he/she should only momentarily leave the game to make a purchase without ever feeling as though he/she has actually left the game. In other words, the solution should be wholly integrated into the various parts of the gaming experience.

A need exists for an in-game e-commerce solution that allow the game publisher to monetize game activities by enabling publisher-to-player and player-to-player micro-transactions, virtual currencies, and traditional user and subscription management services. In addition, a need exists for an in-game e-commerce solution that can be developed and hosted by the game publisher itself. Ideally, integration with a third-party application would allow the game publisher to maximize the financial potential of its title, focusing on the creativity of the game and outsourcing the complex in-game commercial ecosystem. Web services and the standardized tools and protocols developed around them could allow a game publisher to partner, and integrate their system, with world class third-party service providers who concentrate their efforts on being the best at what they do.

The World Wide Web Consortium, W3C, defines a web service as a software system designed to support interoperable machine-to-machine interaction over a network. Web services are frequently web APIs that can be accessed over a network, such as the Internet, and executed on a remote system hosting the requested application and services. Web services allow for loose coupling of applications. This web services approach is much more dynamic and flexible than the approach of building an application as a collection of tightly coupled components or subroutines. Loose coupling and modularization into web services would allow a game publisher to choose and integrate only those services that it requires. Further, the publisher may choose to develop and host some services itself, and outsource others.

The W3C Web service definition encompasses many different systems, but in common usage the term refers to clients and servers that communicate using extended mark-up language (XML) messages that follow the Simple Object Access Protocol (SOAP) standard. Common in both the field and the terminology is the assumption that there is also a machine readable description of the operations supported by the server, a description in the Web Services Description Language (WSDL). The latter is not a requirement of a SOAP endpoint, but it is a prerequisite for automated client-side code generation in the mainstream Java and .NET SOAP frameworks. Some industry organizations, such as the WS-I (an industry consortium whose primary goal is to promote the adoption of web service technology), mandate both SOAP and WSDL in their definition of a Web service.

Web services tools can be used in a number of ways. The three most common styles of use are remote procedure calls (RPCs), service-oriented architecture (SOA) and representational state transfer (REST). RPC web services present a distributed function (or method) call interface that is familiar to many developers. The RPC allows a program on one computer to execute a program on a server computer. Using RPC, a system developer need not develop specific procedures for the server. The client program sends a message to the server with the appropriate arguments and the server returns a message containing the results of the program executed. Typically, the basic unit of RPC Web services is the WSDL operation.

The first Web services tools were focused on RPC, and as a result this style is widely deployed and supported. However, it is sometimes criticized for not being loosely coupled, because it was often implemented by mapping services directly to language-specific function or method calls.

Web services can be used to implement architecture according to service-oriented architecture (SOA) concepts, where the basic unit of communication is a message, rather than an operation. This is often referred to as “message-oriented” services. SOA concepts focus on the design of a system's interface which may be used in multiple business contexts. With an SOA, all functions or services are defined using a description language and have invokable interfaces that are called to perform business processes. Each interaction is independent of each other interaction and the interconnect protocols of the communicating devices. Interfaces are platform independent, so a client from any device using any operating system in any language can use the service.

SOA web services are supported by most major software vendors and industry analysts. Unlike RPC Web services, loose coupling is more likely, because the focus is on the “contract” that WSDL provides, rather than the underlying implementation details.

Finally, RESTful web services attempt to emulate HTTP and similar protocols by constraining the interface to a set of well-known, standard operations (e.g., GET, PUT, DELETE). Here, the focus is on interacting with stateful resources, rather than messages or operations. RESTful web services can use WSDL to describe SOAP messaging over HTTP, which defines the operations, or can be implemented as an abstraction purely on top of SOAP (e.g., WS-Transfer).

Simple Object Access Protocol (SOAP) provides a simple and lightweight mechanism for exchanging structured and typed information between peers in a decentralized, distributed environment using extensible markup language (XML). SOAP does not itself define any application semantics such as a programming model or implementation specific semantics; rather it defines a simple mechanism for expressing application semantics by providing a modular packaging model and encoding mechanisms for encoding data within modules. This allows SOAP to be used in a large variety of systems ranging from messaging systems to RPCs.

SOAP consists of three parts: The SOAP envelope construct defines an overall framework for expressing what is in a message; who should deal with it, and whether it is optional or mandatory. The SOAP encoding rules defines a serialization mechanism that can be used to exchange instances of application-defined datatypes. The SOAP RPC representation defines a convention that can be used to represent remote procedure calls and responses.

A number of additional technologies are available for web services and application development. The breadth and depth of existing functionality and the very large number of users make Java the most desirable programming language for developing web services and applications. There are hundreds of freely available third-party libraries in existence to enhance the core Java API. This makes Java very cost effective, since a developer does not have to start from the ground up. Reusing APIs from third-party libraries typically means they have been tested in live projects, resulting in a more reliable and robust solution.

Third-party libraries are available for developing a preferred embodiment of a modular in game commerce system and method. For example, Hibernate™ is a middleware technology that provides an Object-Relational mapping framework allowing programmers to develop persistent classes, and freeing the developer from writing SQL scripts. Reading, updating or adding data is accomplished by automatically created HQL queries. Hibernate™'s interoperability allows the use of a number of different databases, allowing the back end to switch to others that may be found more effective over time.

Spring is a Java framework that offers a wide spectrum of functionality. For example, it may be used for dependency injection, transaction management and batch processing. Built-in features increase development productivity and system performance and reliability.

Wicket is another web development framework that may be used in developing web services. A key feature is that it allows for the separation of markup language and Java code. It establishes the link between Java code and HTML. The clear delineation between Java and HTML reduces the amount of complexity required in the development of the Java components.

The Wicket template engine allows the loose coupling of front-end and back-end code. The main advantage of using templates is their reusability for different views and different clients. Another great advantage is that the use of templates allows the asynchronous development of functional and presentation code.

Wicket comes with a javascript library, YUI. This library is fully integrated into Wicket and supports the building of richly interactive web applications using techniques such as DOM scripting, DHTML and Ajax. This library has been used to add some “desktop application known” behavior to the front-end, such as drag and drop functionality. The power of Ajax has also been employed to improve the customer experience by only refreshing or updating those parts of a page for which it is necessary.

JMX, the Java Management Extension Library, is used to manage, monitor and control applications. It may be used to track processing time for every function call, allowing a developer to discover and delete bottlenecks to enhance performance.

JUnit is a framework used for automatic testing. JUnit tests are developed for every use case. Developers are only allowed to check in new or updated code if all JUnit tests are still successful. Using JUnit makes the testing process easier and the system more reliable. JUnit makes the testing process more reliable, but manual tests and JMeter tests may also be used.

The use of a cluster of widely used web and application servers add to the stability and high performance of a modularized in-game commerce system. Apache web server is a widely used server with proven reliability. It is under continuous development by the open source community and new stable and richer versions will be released in the future.

As the server receives all incoming requests, it communicates through a standard protocol, http. The server handles the establishment of secure connections (SSL) and is configured to act as a load balancer in front of an Apache Tomcat Cluster. Requests for dynamic content is redirected to a single node of the cluster, the communication takes place through the Apache JSery protocol. The Apache Web server is capable of high performance URL rewriting, which offers broad opportunities for platform design. This feature also provides application architects with a high level of future proofing in design.

A Tomcat application server receives requests for dynamic content from the web server. This is a robust server, particularly well-suited for Java programming, as it is the reference implementation of Sun Microsystems Servlet Specification. Like the Apache web server, it is under continuous development and all specification improvements will first be available in new stable versions of Tomcat.

Sequoia, or its successor, Tungsten, database clustering middleware provides communication between the application server and the database, load balancing and failover services. These middleware solutions sit in front of a database cluster acting as a load balancer. Queries are sent to the database cluster node with the most available resources.

Many or all of these tools may be used to create a flexible, robust set of web services for a comprehensive marketplace and transaction management solution with a specific focus on trading and managing virtual assets such as in-game items or in-game services. There is a need for a system that provides a world class e-commerce system composed of autonomous modules which allow a game publisher to choose only those that fit its particular requirements. The present invention provides a solution to these needs and other problems, and offers other advantages over the prior art.

### BRIEF SUMMARY

The present disclosure relates to the provision of in-game e-commerce services using a turn-key business model. E-commerce functions for all monetizable game activities and publisher sales may be seamlessly integrated with a game hosted on a publisher's site. Seamless integration means that the player is always aware of his purchasing power and abilities but never aware that he has left the game. A modular design supports both publisher-to-player and player-to-player markets as well as billing and customer management.

In accordance with one embodiment of the invention, a modularized in-game e-commerce system is operatively coupled through a network to a game application. The e-commerce system includes a server with a processor and a memory. The e-commerce system also contains an account management and storefront management modules of program code which when executed by the server performs operation of certain web services. These account management module web services include an account service that manages user profiles and accounts. Each user account contains a wallet and an account identity within the game application. An inventory service manages items owned by an account identity for each user account. A wallet service manages a balance with the wallet for each user account. The storefront management module web services include an item service and a search service. The item service manages a catalog of items offered in a storefront within the game application. The search service retrieves data from the catalog for presentation within the game application storefront. The e-commerce system also optionally includes a purchasing management module with a notification callback web service. Each of these web services include one or more programming code methods that implement processes managed by the web services.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 illustrates an in-game commerce solution in context.

FIG. 2 illustrates the system service architecture of a modularized in-game commerce solution.

FIGS. 3a and 3b illustrate the software architecture for a modularized in-game commerce solution.

FIG. 4 is an abstract illustration of the request handling procedure in an in-game e-commerce solution.

FIG. 5 illustrates an exemplary request preprocessing procedure in an in-game e-commerce solution.

FIG. 6 illustrates an exemplary request processing procedure in an in-game e-commerce solution.

FIG. 7 illustrates an exemplary request post-processing procedure in an in-game e-commerce solution.

FIGS. 8a-8c illustrate module structures for the primary use cases associated with a preferred embodiment of an in-game e-commerce solution.

### DETAILED DESCRIPTION

As the popularity of online gaming continues to grow, gaming merchants are finding new opportunities to satisfy their customers' desires while increasing revenue. An in-game e-commerce solution allows the game publisher to monetize game activities by enabling publisher-to-player and player-to-player micro-transactions, virtual currencies, and traditional user and subscription management. A third-party application allows the game publisher to maximize the financial potential of its title; the publisher focuses on the creativity of the game and outsources the complex in-game commercial ecosystem to a provider who specializes in that area.

A modular in-game e-commerce system is a comprehensive, modular product with seamless in-game integration capabilities. The solution supports publisher-to-player and player-to-player environments. Both real money funding and virtual currency trading are supported, as is management of virtual economies and multiple virtual currencies. A comprehensive in-game e-commerce solution emphasizes global operation including multi-currency, multi-language, multi-VAT, etc. It provides industry-leading financial services (stored value Merchant of Record, fraud prevention, tax and compliance).

A preferred embodiment of a modularized in-game e-commerce solution is designed using the best practices of modular software design, balancing the choice of functionality in each module with the complexity of integration. An effectively designed modular system has a number of desirable features, including the ability to break the tasks down into smaller-sized tasks, or decomposability. It must have the ability to reuse or assemble components into a new system and thereby avoid reinventing the wheel, also known as composability. Additionally, an effective system must have the ability to be understood as a standalone unit, without reference to other modules (understandability). If small changes are made to a particular module or modules, the impact of the change-induced side effects should be relatively contained. And finally, if an error or aberrant condition occurs within a module, the effects of the condition or error should be contained within that module(s). A preferred embodiment of an in-game e-commerce system meets all of these criteria while providing seamless integration with the game.

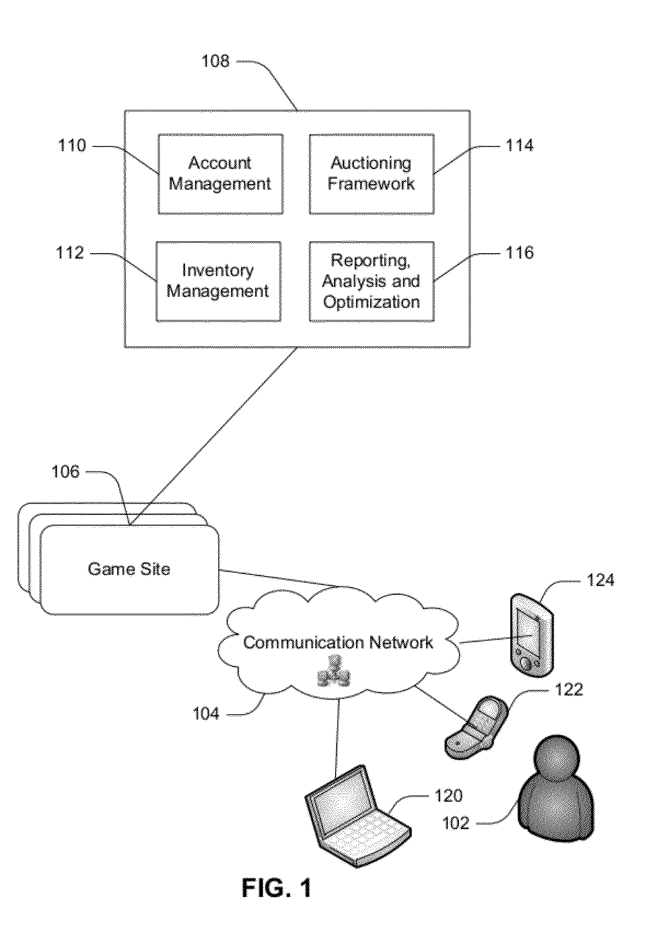

An exemplary system is illustrated in FIG. 1. Online game enthusiasts 102 access game sites that host game applications 106 over the internet 104. Players frequently want to purchase objects that enhance their enjoyment of the game or allow them to achieve some advantage over other players. For example, a player with certain tools or weapons may be able to able to defeat other players in game activities. The game publisher may host its own commerce system allowing players to purchase such virtual objects (or physical objects), or it may wish to access a third-party, fully developed e-commerce system 108. Such an e-commerce system may include any number of modules to facilitate such transactions, for instance, an account management module 110 to register players and maintain payment methods, and an inventory management module 112 to maintain an item catalog and inventory. The e-commerce system may include an auctioning framework module 114 to accommodate player-to-player trading or selling if that is desired. Reporting, analysis and optimization modules 116 may be provided for game publishers to report revenue, track disputes, analyze user behavior or optimize item offers, and more.

In the exemplary system of FIG. 1, players 102 generally access a game site with a game application 106 via an electronic device with internet capabilities. Such an electronic device could be a computing device, such as a personal computer 120, an iPad, a cell phone 122, or a personal digital assistant 124 (PDA). This exemplary system includes various computers, computing devices or electronic devices, including, for example, end user machines (such as a personal computer, iPad, cell phone, or personal digital assistant (PDA)), web site servers 106, an e-commerce system or platform and web services 108 hosted on one or more servers (i.e., computing devices). Each computer or computing device is connected with a network 104 such as the Internet or other type of data network.

The computer, computing or electronic device typically includes a memory, a secondary storage device, a processor (central processing unit, or CPU), an input device, a display device, and an output device. The memory may include random access memory (RAM) or similar types of memory. Software applications, stored in the memory or secondary storage for execution by a processor are operatively configured to perform the operations of the exemplary system. The software applications may correspond with a single module or any number of modules. Modules are program code or instructions for controlling a computer processor to perform a particular method to implement the features or operations of the system. A general purpose computing device is transformed into a specialized computing device when the modules are executed to perform the particular method defined by the program code. The modules may also be implemented using program products or a combination of software and specialized hardware components. In addition, the modules may be executed on multiple processors for processing a large number of transactions, if necessary or desired.

The secondary storage device may include a hard disk drive, floppy disk drive, CD-ROM drive, DVD-ROM drive, or other types of non-volatile data storage, and it may correspond with the various equipment and modules shown in the figures. The processor may execute the software applications or programs either stored in memory or secondary storage or received from the Internet or other network. The input device may include any device for entering information into computer, such as a keyboard, joy-stick, cursor-control device, or touch-screen. The display device may include any type of device for presenting visual information such as, for example, a computer monitor or flat-screen display. The output device may include any type of device for presenting a hard copy of information, such as a printer, and other types of output devices include speakers or any device for providing information in audio form.

Although the computer or computing device has been described with various components, one skilled in the art will appreciate that such a computer or computing device can contain additional or different components and configurations. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. One skilled in the art would recognize that computing devices may be client or server computers. Client computers and devices (e.g. 120, 122, or 124) are those used by end users to access information from a server over a network, such as the Internet 104. Servers are understood to be those computing devices 106 that provide services to other machines, and may be (but are not required to be) dedicated to hosting applications or content to be accessed by any number of client computers. Web servers, application servers and data storage servers may be hosted on the same or different machines.

Web services are self-contained, modular business applications that have open, Internet-oriented, standards-based interfaces. According to W3C, the World Wide Web Consortium, a web service is a software system “designed to support interoperable machine-to-machine interaction over a network. It has an interface described in a machine-processable format (specifically WSDL). Other systems interact with the web service in a manner prescribed by its description using SOAP messages, typically conveyed using HTTP with an XML serialization in conjunction with other web-related standards.” Web services are similar to components that can be integrated into more complex distributed applications. A number of standard technologies are used with web services and were discussed above.

While the system disclosed herein is described in the context of internet gaming, it will be recognized by those skilled in the art that it may be used with other applications as well. Further, while specific modules are described, other modules may be added or deleted without departing from the scope and spirit of the present invention.

### Three-Tier Architecture

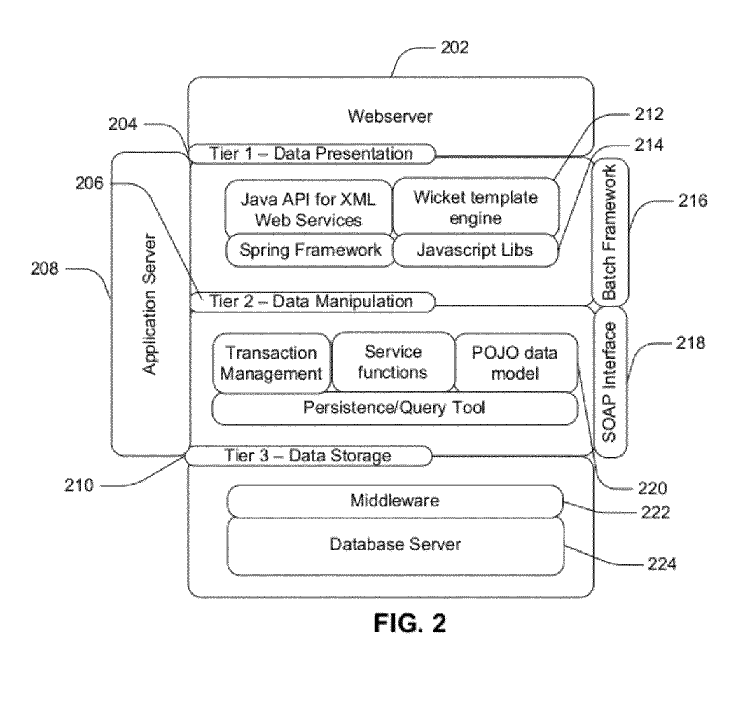

A preferred embodiment of a modularized in-game e-commerce solution (i.e., e-commerce system 108) is a three tier client/server system as is illustrated in FIG. 2. The three tier architecture depiction of the e-commerce system 108 is a client server based architecture which physically separates the software into three layers. The advantage of this architecture lies within the simplicity of development and maintenance of the application. The separation makes it easy to locate errors and the main advantage is to scale the platform simply by adding hardware to the tier where performance improvements are required.

Referring to FIG. 2, the three tiers of the e-commerce system 108 are:
Tier 1: Presentation 204
Tier 2: Data manipulation 206
Tier 3: Data storage 210

Such an application may be developed using plain Java supported by a web development framework, such as Wicket. The use of plain Java provides enormous flexibility with the choice of the application server. Widely accepted, open-source software may be used where appropriate within the design. This approach could be adopted for components where the overall cost-benefit is greater than with ground up development.

The environmental configuration of the application may be primarily based on two well-known architectural models, specifically Service Oriented Architecture (SOA) and Model, View and Controller (MVC) architecture. SOA ensures that each service is hosted on a separate server and that it is available to the network. Each service executes independently and provides interfaces to the other services. The advan-tage of this setup allows the company to respond more quickly and more cost-effectively to changing market conditions. The MVC Java model is a proven architectural pattern whereby the separation of the Model, View and Controller is defined. MVC application architecture allows the developer to map directly to the physical three tier architecture. Model components are represented at tier 1 204, presentation; View components at tier 2, data manipulation 206; and controllers at tier 3, data storage 210.

### Tier 1—Data Presentation

Apache web server software may be used as the web server 202. Apache is a widely used and robust web server which is available as an open source solution. The Apache web server is capable of high performance URL rewriting, which offers broad opportunities for platform design. This feature provids application architects with a high level of future proofing in design.

The application, which may be hosted on an application server such as the Tomcat Application Server 208, is preferably written in plain Java. At this layer interactions between the web development framework, such as Wicket, and the application are performed. The application server 208 is preferably implemented over two tiers. Within tier one 204 it may handle the presentation logic from Wicket's template engine 212 and within tier two 206 it may handle the manipulation logic with Wicket's POJO (Plain Old Java Objects) 220 data models.

The Tier 1 data presentation layer 204 is responsible for receiving user input and responding with application output. User input can either be information provided within a form, or input provided by attributes stored within the URL.

In a preferred embodiment, use of the Wicket framework allows the separation of mark-up language and Java code. This web development framework establishes the link between Java code and HTML. The clear delineation between Java and HTML reduces the amount of complexity required in the development of the Java components. The loose coupling of front-end and back-end code allows developers and designers to work closely together whilst enabling them to develop independently. Additionally, this framework provides a very flexible environment for the implementation of a preferred embodiment of a front-end application on different devices, such as mobile phones.

Internationalization (I18N) support is handled at the Tier 1 level. Wicket supports the translation of pages on the fly coupled with heavy caching features to maintain the high performance required. DBCS (Double Byte Character Set) is supported by the platform, thus enabling a roll out of the service to Asia if required.

The Wicket framework also comes with an Ajax JavaScript library 214, YUI, which offers a set of utilities and controls, written with JavaScript and CSS. This library is fully integrated into Wicket and supports the building of richly interactive web applications using techniques such as DOM scripting, DHTML and AJAX. The JavaScript library has been used to add some “desktop application known” behavior to the web-front end such as drag and drop. The power of AJAX has also been employed to improve the customer experience by only refreshing or updating those parts of a page that are necessary.

A Wicket template is only text that is intended to separate the presentation of a document from its data. A template defines placeholders and various bits of basic logic (i.e., template tags) that regulate how the document should be displayed. Usually, templates have the advantage of being reusable for different views. The real advantage of the use of templates is that it allows the asynchronous development of functional code and presentation code.

Full web services are offered via SOAP interface 218 which allows external partners to interact with the platform via API calls. SOAP packages the data needed by a message recipient and binds it to a transport action. It is a standardized protocol that provides reliable messaging from one system to another over the internet.

### Tier 2—Data Manipulation

The application resides in tier 2. Tier 2 is responsible for manipulating the data by receiving data inputs from tier 1 which are either made by the end-user via form entries, or which are retrieved from attributes contained within the URL. This layer requests and retrieves data from tier 3 and manipulates this data. This layer is re-sponsible for building the contents of a customer's store and for handling payment transactions. This system uses a POJO (Plain Old Java Object) data model 220, which allows the development of a loosely coupled application, and greater flexibility.

Payment middleware is located in this tier and supports payment connections to several billing partners, including: Paypal, clickandbuy, credit card institutes, mpay24, prepaid debit card, gift card and others.

This interface is open for any other payment platform to support more payment options.

### Tier 3—Data Storage

Tier 3 handles data storage utilizing a MySQL or Oracle database. The application, which resides within tier 2, stores data to the database by sending the data to tier 3 and extracts data out of the database by passing requests to tier 3. A middleware application 222, such as Hibernate, sits between the java application and the database. Hibernate abstracts the database queries to allow dynamic exchange of database servers by supporting an object-relation-mapping. Using this approach provides more flexibility in the choice of the backend database using HQL (Hibernate Query Language), so while MySQL or Oracle databases 224 are preferred, any database may be utilized. The architecture may be configured to support replicated DB servers.

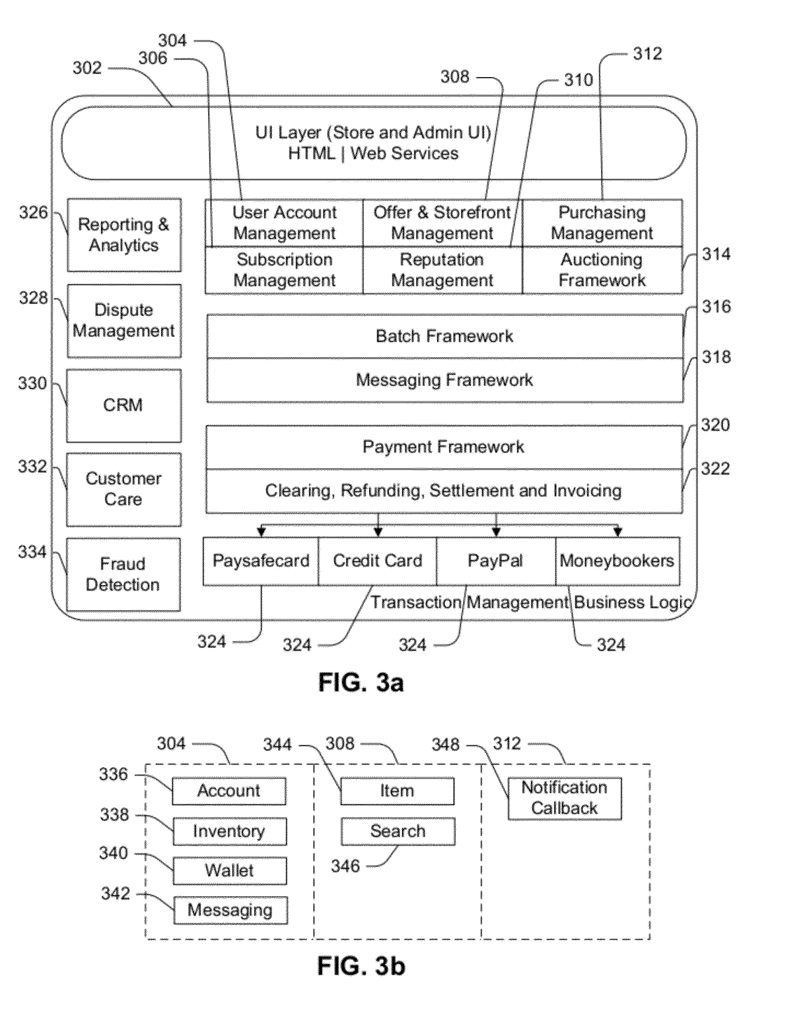

The three tier structure can also be viewed from a functional perspective, as in FIG. 3a. A user interface (UI) layer 302 is exposed to clients and client systems. A store and administrative user interface provides manual access to the system for the various administrative tasks associated with the functional modules provided. For example, an administrative user may log into the UI, to setup an item or offer, run reports, perform dispute resolution and conduct analysis on offers and users. These examples are offered by way of example and not limitation. One skilled in the art would recognize that many types of functionality could be provided for a game publisher, system administrator or others to perform through a user interface without departing from the scope and spirit of the present invention.

A functional layer provides the code required to perform the transactions as well as store, maintain, access and retrieve data. Also by way of example, these various modules which are implemented as a collection of web services may include user account management 304, offer and storefront management 308, purchasing (notification) management 312, subscription management 306, reputation management 310, an auctioning framework for player-to-player secondary markets 314, reporting & analytics 326, dispute management 328, customer relationship management 330, customer care 332, fraud detection 334, and Clearing, Refunding, Settlement and Invoicing module 322.

A customer care or customer support module 332 provides full insight into all relevant platform activity performed by users. Following strict data protection and privacy guidelines the support agent has access to browsing behavior and all relevant transaction information. Agents may also modify user data, add personal information only visible to the care organization, or active/reactivate users. Agents with additional permissions can also reverse payment transactions (i.e., refund or chargeback the transaction), refund the customer directly or initiate the payout after closing the case.

A fraud detection module 334 allows the game publisher to detect and manage fraud across channels and accounts. In addition, results of fraud scoring and case management are fed back into the legacy systems from which the fraud originated. This allows the publisher to further refine fraud detection on its site.

A batch framework 316 facilities communications between the system and payment providers or internal modules that require the transfer of information infrequently or on a predetermined schedule. A messaging framework 318 such as RabbitMQ is provided to allow external partners to interact with the platform via API calls.

A payment Framework 320 (e.g., for recurring payments) may utilize a traditional

API-based transaction flow, or a payment page, either hosted on the in-game e-commerce platform or by a third party payment provider. With a payment page solution, the buyer is redirected to a URL which displays a payment page where a payment method is selected and payment data entered. The payment provider performs the transaction with the issuing bank or service, and returns the result on redirect to the in-game e-commerce system. Clearing, refunding, settlement and invoicing may be facilitated by the batch processing framework 316, and communicated directly to the issuing bank or service 324.

It will be apparent to one skilled in the art that other modules may be added to accomplish other functions required of an in-game e-commerce system

### Session Management

For client side session management of a preferred embodiment, up to three cookies are stored by the client, if cookies are enabled. The client side session stores
the key for the server side session.
a cookie to handle the re-entrance in case of auto-login
a cookie to handle the detection of language, if the language on his last visit was different to his browser language.

For server-side session management, serializable session objects may be stored to handle the application and request flow. The application may use an open source software implementation such as Tomcat session replication for storing the session. A load balancer may use IP-sticky binding (for reason of SSL/nonSSL) so the standard case requires no session replication to the other cluster member(s). Actually the session is stored on file system, limited to 32k parallel sessions (linux limiting value for directories). Additionally the software architecture of an in-game e-commerce system and method supports storing session data in the database.

### System Request Flow and Request Handling

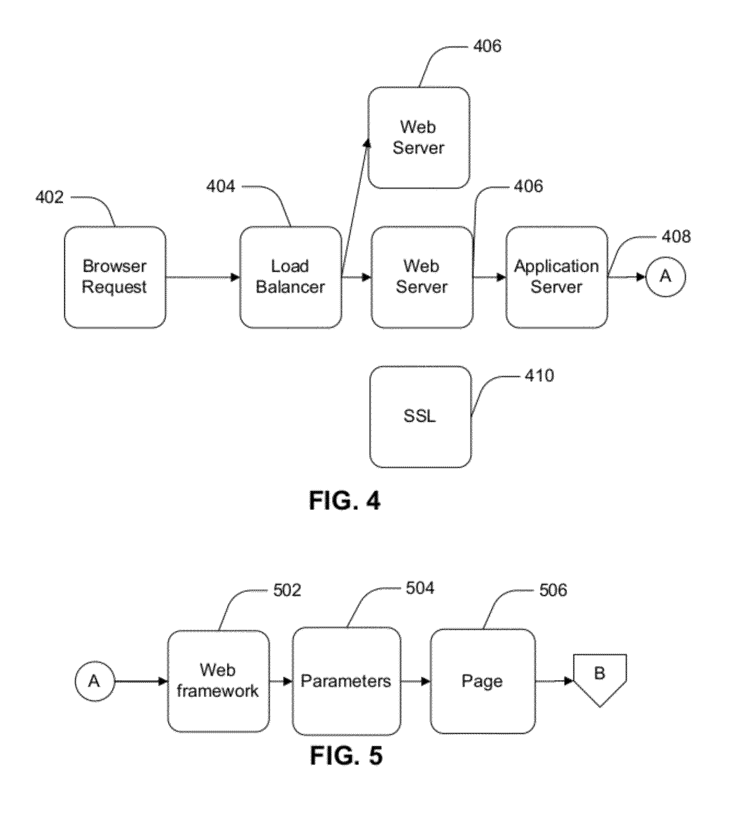

FIGS. 4 through 7 illustrate the handling of a request by a platform for a user. A request made via a browser 402 may be directed through load balancers 404 to one of the system's web servers 406. The web server should be capable of high performance URL rewriting, which offers broad opportunities for platform design. This feature provides application architects with a high level of future proofing in design. Every request may be conducted through a Secure Sockets Layer (SSL) handler 410 which checks first if the requested page is part of a secure pages matching table and triggers a HTTPS redirect to our application server.

The main application is deployed on an application server 408, such as the Tomcat Application Server, and receives the request from the web server connector. The application server automatically generates the HTTP session for every request. If cookies are not support on the client, the application server and Wicket are capable of adding the session id to the URL. Interactions between the Wicket web development framework and the application are performed at this layer.

### Request Pre-Processing

Following the initial handling of the incoming request, it is handed over from the application server 408 to the web framework 502 where the parameters of the accepted URL request are analyzed by the parameters module 504 to decide which page setup strategy 506 should be executed.

The page handler 506 evaluates what the type of page has been requested and whether the request class is valid. In a preferred embodiment, the following request handlers may be available: Form Processing 606, Page Request 612 or Ajax Request 616.

Subsequently, the system request flow is processed via the “on-page” request handler 506 where an additional session for this user/request will be generated. This overlaying session contains detailed information about the IP address, browser type/version, basket ID and page browsing history. This session will be stored as a permanent cookie to reassign the user after he has logged out and logged back in again.

After having successfully classified the request 602, a dedicated transaction is opened through a persistence/query service (such as Hibernate) 604 into the database 610. Request handlers perform their functions and write the processed data to the database. This action closes the pre-processing phases and initiates the active processing of the system request.

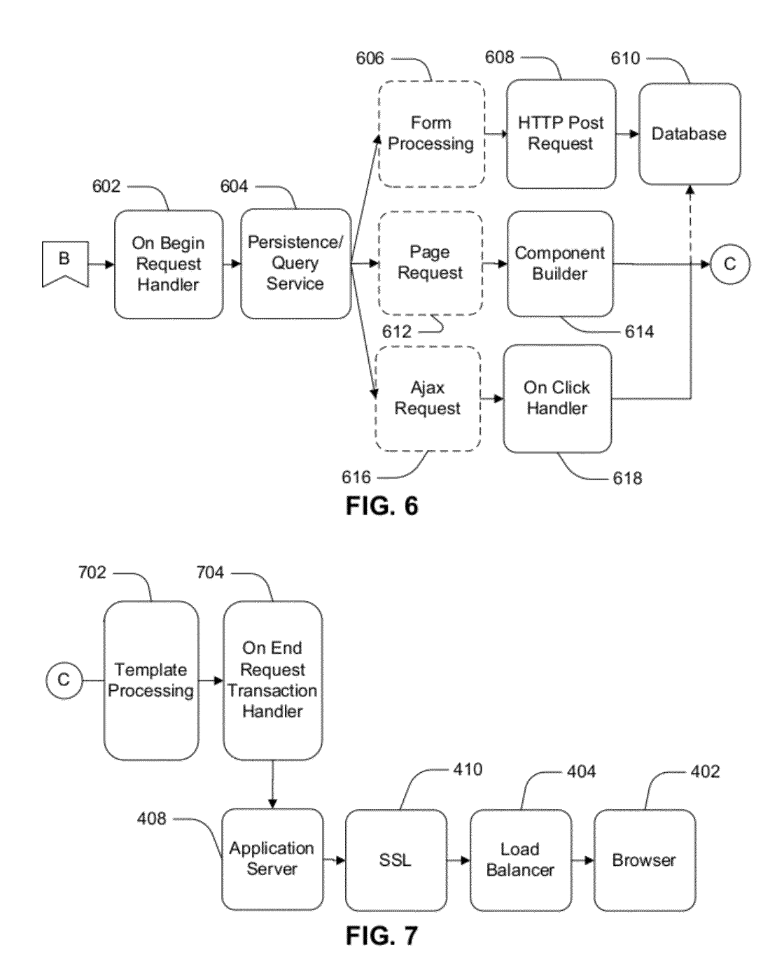

FIG. 6 illustrates a flow for request processing. Based on the evaluation of the request during the pre-processing phase the request will be executed as a form processing request 606, a page request 612, or an Ajax request 616. A form processing request 606 is handled as an HTTP Post requested to transmit and store data on submit to the database. Based on the request a redirect or (Ajax or full page) template processing 702 will be executed in the post request processing phase. A page request may follow a linear approach going through all components to build them up in a step-by-step manner (e.g. Page, header components, panels) within the component builder 614 in the post processing phase.

All data that need to be manipulated or refreshed may be processed via the “On-click-handler” 618 which will refresh or simply present the data via JavaScript request within an Ajax template. An Ajax engine is intended to suppress the delays perceived by the user when a page attempts to access the server; therefore most of the system requests will be handled as Ajax requests to optimize performance and perception of the platform usage.

### Post Processing

A template processing handler 702 creates HTML or XML pages initialized and based on the outcome of the pre-evaluation process of the request that need to contain a page request or a request to rebuild at least one component. This handler will additionally manage the caching for the platform to enable an optimized performance. The sub related “on-end-transaction-handler” 704 will closed afterwards the transaction within the database or creates alternatively a rollback if an error occurs.

In general system requests may create pages that are rendered by a combination of server-side and client-side XHTML or XML generation and manipulation. Ajax techniques especially enable a system to communicate user actions to the server via server-side code, which manipulates a server-side component model. Changes to the server component model are reflected on the client automatically.

In a preferred embodiment system, system request flows are executed by processing the requests, searching for or manipulate the data, and transmitting it to the browser in the most efficient way possible. The system determines if significant performance improvements can be achieved via defining a limited set of requests that will result in a database transaction and need to be therefore processed. This additional logic could be handled within the “on-begin-handler” 602.

### Functional Modules

A preferred embodiment of a modular marketplace and transaction management solution capable of covering all aspects of game-relevant monetization is optimized to perform three primary areas of functionality. This functionality includes: billing and customer management; publisher to player trading (a primary marketplace); and player to player trading (a secondary marketplace). The level of modularization of this functionality allows for quick and easy integration with the online game client and at the same time maximizes the flexibility required for the user-interface, business model or exposed feature set. All modules are designed to work autonomously in order to allow other existing solutions to cover features and functionalities, if required.

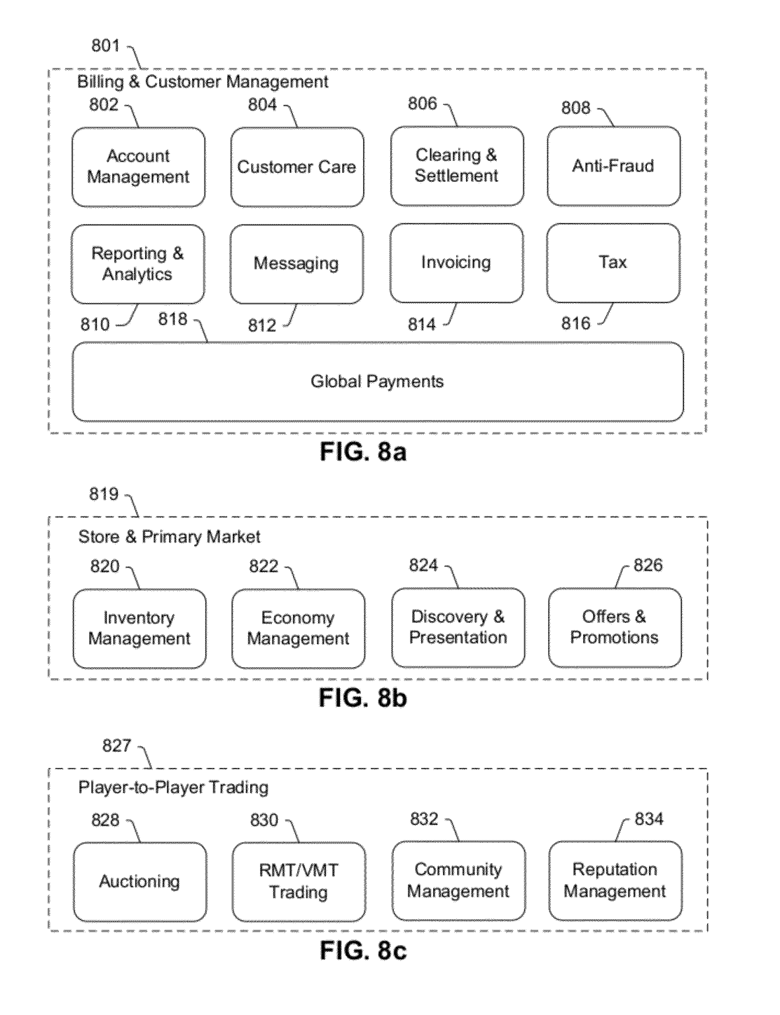

FIGS. 8a-8c illustrate the modular distribution with business logic organized around the three primary areas of functionality implemented as a collection of web services. An exemplary system supporting a billing and customer management functions 801, as shown in FIG. 8a includes the following modules: account management 802 (e.g., web services such as account service, inventory service, and wallet service), customer care, 804, clearing & settlement 806, anti-fraud 808, reporting & analytics 810, messaging 812, invoicing, 814 and tax 816. The subscription billing and management system is integrated with a global payments system 818 to handle credit card and other payment processing.

Referring to FIG. 8b, a store and primary market (publisher-to-player) feature 819 consists of an inventory management 820, economy management 822, discovery and presentation 824 and offer & promotion 826 modules providing storefront management functionality.

A player-to-player trading feature 827 is illustrated in FIG. 8c. This feature has functionality that includes auctioning 828, RMT/VMT trading 830, community management 832 and reputation management 834 modules.

Referring to FIG. 3a, examples and illustrations of the functionality provided by Account Management 304, Storefront Management 308 and Purchasing (notification) Management 312 modules is described below.

### Account Management

An account management module 304 (also referred to as account management module 802 in FIG. 8a.) may provide a number of web services as shown in FIG. 3b, such as account 336, inventory 338, wallet 340, and messaging/mail 342 services. Account services 336 are used to manage user profiles. A user profile exists for every user account, including those system accounts for maintaining storefront servers and client back-end servers, back office users including customer care users and system administrators, and consumers. User accounts may have one or more account identities in their user profile that can be used to represent sub-accounts within a game publisher's application 106 on the game site. For example, an account identity might exist for each avatar owned by a player in a game application 106.

An account service 336 offers a variety of functionality through various methods, including, but not limited to, creating user accounts, activating/deactivating users, view or modify user profiles, view or modify risk profiles, upgrade user accounts to merchant accounts. A remote account services module may require the use of a key to be used when calling the services (e.g. account 336, inventory 338, wallet 340) via account services APIs. All requests are handled via web services (WSDL and SOAP).

A number of methods facilitate transactions in this account service 336 and are listed in Table 1 and detailed in Tables 3 through 20. A publisher can offer a player-to-player secondary market which would create Merchant accounts for all users in order to provide the ability to sell content in that market.

TABLE 1
Account Services Methods

| Method | Description |
|---|---|
| createAccount | Creates a basic purchasing account and returns AccountID of |
| | the created user account |
| createMerchantAccount | Upgrades a user account to a merchant |
| createIdentity | Creates an identity on an existing account |
| modifyAccount | Modifies the account with the provided AccountDetails |
| modifyAddressDetails | Modifies the account with the provided AddressDetails |
| modifyCustomDataDetails | Updates the custom data on an existing account |
| updateIdentity | Updates an existing identity |
| deleteAccount | Deletes an existing account |
| deleteIdentity | Deletes an existing identity |
| getAccountDetails | Returns details for an existing account |
| findAccount | Retrieve accounts that match a given set of criteria |
| getIdentity | Retrieve details for an existing identity |
| getIdentities | Retrieve identities associated with an account |
| getSubscriptionDetails | Retrieve the active subscriptions associated with the given |
| | account and identity |
| findIdentity | Retrieve identities that match a given set of criteria |
| login | Authenticates login credentials and retrieve a session for a |
| | user |
| logout | Logs out a logged-in user |
| handshake | Retrieves a one-time user token suitable for use in redirecting |
| | a user to a third party hosted application without requiring the |
| | user to log-in again (i.e. single sign on) |

All access to web-services requires encryption in the form of SSL or a dedicated VPN. FFG test systems use a self-signed certificate that you will need to add to your certificate store in order to access the environment. Your technical contact can provide the current certificate to you during setup. System to system authentication for all FFG Platform web-services follows a generic pattern. Each web service request includes a “key” element with the parameters listed in Table 2. Only the “key” attribute is required, but it's strongly recommended that the optional parameters be provided to enhance traceability of transactions for fraud detection and system debug purposes.

TABLE 2
Authentication

| Parameter | Req'd? | Type | Description |
|---|---|---|---|
| key | Yes | Object | Encapsulates security token |
| | | | information. |
| key.accountId | No | String | The FFG account ID of the caller. |
| key.ip | No | String | The IP address of the caller. Used |
| | | | for security analysis and |
| | | | traceability. |
| key.key | Yes | String | A credential used to authenticate |
| | | | the caller. Configured when the |
| | | | system is setup. |
| key.uuid | No | String | Unique identifier of the request. If |
| | | | provided, subsequent requests with |
| | | | the same UUID will be ignored. |

TABLE 3

| | | | |
|---|---|---|---|
| Parameter | Req'd? | Type | Description |

a. createAccount Method

| | | | |
|---|---|---|---|
| key | Yes | Object | Encapsulates security token |
| | | | information. |
| key.accountId | No | String | The FFG account ID of the account |
| | | | making the call. |
| key.ip | No | String | The IP address of the user making the |
| | | | call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| nickname | Yes | String | The username of the account. |
| email | Yes | String | The email of the user. |
| password | No | String | The optional password of the user's |
| | | | account. The password should be |
| | | | provided if the user will be accessing |
| | | | the FFG hosted Admin interface or if |
| | | | you are not using single-sign on. |
| locale | Yes | String | The locale of the user. The available |
| | | | locales are configured for your |
| | | | application during setup. |

b. createAccount Response

| | | | |
|---|---|---|---|
| return | Yes | String | The nickname of the account created. |

TABLE 4

| | | | |
|---|---|---|---|
| Parameter | Req'd? | Type | Description |

a. createMerchantAccount

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with the |
| | | | same UUID should be ignored. |
| accountDetails | Yes | Object | The details for the account. |
| accountDetails.accountId | Yes | String | A unique identifier for the account. |
| accountDetails.addresses | No | Object | The list of addresses in the consumer |
| | | | account. |
| accountDetails.addresses.AddressDetails | Yes | Object | The details for an address. |
| ...AddressDetails.active | Yes | Boolean | Whether the account is currently |
| | | | active. |
| ...AddressDetails.addressDetailId | Yes | String | A unique identifier for the address. |
| ...AddressDetails.addressStatus | No | String | An optional address status that can be |
| | | | used to track the external status of the |
| | | | address. |
| ...AddressDetails.city | Yes | String | The city of the address. |
| ...AddressDetails.company | No | String | The company name of the address. |
| ...AddressDetails.countryCode | No | String | |
| ...AddressDetails.countryIsoCode | No | String | The ISO country code of the address. |
| ...AddressDetails.defaultBilling | Yes | Boolean | Whether the address should be the |
| | | | consumer's default billing address. |
| ...AddressDetails.defaultShipping | Yes | Boolean | Whether the address should be the |
| | | | consumer's default shipping address. |
| ...AddressDetails.email | No | String | The email associated with the address. |
| ...AddressDetails.firstName | No | String | The first name associated with the |
| | | | address. |
| ...AddressDetails.lastName | No | String | The last name associated with the |
| | | | address. |
| ...AddressDetails.phone | No | String | The phone number associated with the |
| | | | address. |
| ...AddressDetails.stateCode | Yes | String | The state code of the address. |
| ...AddressDetails.street1 | Yes | String | The first line of the street address. |
| ...AddressDetails.street2 | Yes | String | The second line of the street address. |
| ...AddressDetails.type | Yes | String | An arbitrary string identifying the |
| | | | address. (E.g., “Home” or “Work”). |
| ...AddressDetails.validFrom | No | Date | The start date after which the address |
| | | | should be considered valid. |
| ...AddressDetails.zipCode | Yes | String | The zip code of the address. |
| accountDetails.birthday | No | Date | The birthday of the user. |
| accountDetails.childAccountRestrictionData | No | Object | Account restrictions applied to child |
| | | | accounts related to this account. |
| accountDetails.companyName | No | String | The company name of the account. |
| accountDetails.creationDate | No | Date | The creation date of the account. |
| accountDetails.customData | No | Object | A set of custom data elements to be |
| | | | stored for the account. |
| accountDetails.customData.CustomDataDetails | Yes | Object | A custom data element. |
| ...CustomDataDetails.freeKey | Yes | String | The key for the custom data. |
| ...CustomDataDetails.type | No | String | The type of the custom data. |
| ...CustomDataDetails.value | Yes | String | The value of the custom data. |
| accountDetails.email | Yes | String | The email of the user. |
| accountDetails.firstName | No | String | The first name of the user. |
| accountDetails.lastName | No | String | The last name of the user. |
| accountDetails.gender | No | String | The gender of the user. |
| accountDetails.language | Yes | String | The language of the user. |
| accountDetails.lastLoginDate | No | String | The last login data of the user. |
| accountDetails.nickname | Yes | String | The username of the user. |
| accountDetails.supportEmail | No | String | User email. |
| accountDetails.termsAccepted | No | Boolean | Whether the terms and conditions have |
| | | | been accepted by the user. |
| accountDetails.timeZoneIdentifier | No | String | The time zone of the user. |
| credentials | No | Object | Credential data for the account. |
| credentials. password | No | String | The password for the account. |
| credentials.securityAnswer | No | String | The security answer for the account. |
| credentials.securityQuestionDemographicId | No | String | The security question ID for the |
| | | | account. |

b. createMerchantAccountResponse

| | | | |
|---|---|---|---|
| return | Yes | String | The account ID of the account created. |

TABLE 5

| | | | |
|---|---|---|---|
| Parameter | Req'd? | Type | Description |

a. createIdentity

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| identityDetails | Yes | Object | A block of identity details. |
| identityDetails.accountId | Yes | String | The ID of the account this identity |
| | | | should be associated with. |
| identityDetails.attributeValues | No | Object | A set of attribute values associated |
| | | | with the identity. |
| | | | Attributes (below) should be used |
| | | | when the attribute is merely a flag on |
| | | | the account (i.e., Is Premium |
| | | | Subscriber). |
| ...attributeValues.AttributeValue | Yes | Object | An attribute value to be associated |
| | | | with the identity. |
| ...AttributeValue.attributeValueType | Yes | String | The type of the attribute value. |
| ...AttributeValue.customText | Yes | String | The value to be applied to the |
| | | | attribute. |
| ...AttributeValue.inGameId | Yes | String | The in-game identifier of the |
| | | | attribute. |
| ...AttributeValue.name | Yes | String | The name of the attribute. |
| identityDetails.attributes | No | Object | A set of attributes associated with the |
| | | | identity. |
| | | | Attribute Values (above) should be |
| | | | used when the identity has a |
| | | | configured value (i.e., Character |
| | | | Level = 5). |
| ...attributes.Attribute | Yes | Object | An attribute associated with the |
| | | | identity. |
| ...Attribute.inGameId | Yes | String | The in-game identifier of the |
| | | | attribute. |
| ...Attribute.name | Yes | String | The name of the attribute. |
| identityDetails.gameIdentifier | Yes | String | The identifier of the game this |
| | | | identity should be associated with. |
| | | | Valid game identifiers are configured |
| | | | during setup. |
| identityDetails.identityDetailsId | Yes | String | A unique identifier for the identity. |
| identityDetails.inGameId | Yes | String | The in-game identifier of the identity. |
| | | | Commonly the character name or the |
| | | | internal ID in your game engine. |
| identityDetails.name | Yes | String | The name of the identity. |

b. createIdentityResponse

| | | | |
|---|---|---|---|
| return | Yes | String | The ID of the account created. |

TABLE 6

| | | | |
|---|---|---|---|
| Parameter | Req'd? | Type | Description |

a. modifyAccount

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| accountDetails | Yes | Object | The details for the account. |
| accountDetails.accountId | Yes | String | A unique identifier for the account. |
| accountDetails.addresses | No | Object | The list of addresses in the consumer |
| | | | account. |
| accountDetails.addresses.AddressDetails | Yes | Object | The details for an address. |
| ...AddressDetails.active | Yes | Boolean | Whether the account is currently |
| | | | active. |
| ...AddressDetails.addressDetailId | Yes | String | A unique identifier for the address. |
| ...AddressDetails.addressStatus | No | String | An optional address status that can |
| | | | be used to track the external status of |
| | | | the address. |
| ...AddressDetails.city | Yes | String | The city of the address. |
| ...AddressDetails.company | No | String | The company name of the address. |
| ...AddressDetails.countryCode | No | String | |
| ...AddressDetails.countryIsoCode | No | String | The ISO country code of the address. |
| ...AddressDetails.defaultBilling | Yes | Boolean | Whether the address should be the |
| | | | consumer's default billing address. |
| ...AddressDetails.defaultShipping | Yes | Boolean | Whether the address should be the |
| | | | consumer's default shipping address. |
| ...AddressDetails.email | No | String | The email associated with the |
| | | | address. |
| ...AddressDetails.firstName | No | String | The first name associated with the |
| | | | address. |
| ...AddressDetails.lastName | No | String | The last name associated with the |
| | | | address. |
| ...AddressDetails.phone | No | String | The phone number associated with |
| | | | the address. |
| ...AddressDetails.stateCode | Yes | String | The state code of the address. |
| ...AddressDetails.street1 | Yes | String | The first line of the street address. |
| ...AddressDetails.street2 | Yes | String | The second line of the street |
| | | | address. |
| ...AddressDetails.type | Yes | String | An arbitrary string identifying the |
| | | | address. (E.g., “Home” or “Work”). |
| ...AddressDetails.validFrom | No | Date | The start date after which the |
| | | | address should be considered valid. |
| ...AddressDetails.zipCode | Yes | String | The zip code of the address. |
| accountDetails.birthday | No | Date | The birthday of the user. |
| accountDetails.childAccountRestrictionData | No | Object | Account restrictions applied to child |
| | | | accounts related to this account. |
| accountDetails.companyName | No | String | The company name of the account. |
| accountDetails.creationDate | No | Date | The creation date of the account. |
| accountDetails.customData | No | Object | A set of custom data elements to be |
| | | | stored for the account. |
| accountDetails.customData.CustomDataDetails | Yes | Object | A custom data element. |
| ...CustomDataDetails.freeKey | Yes | String | The key for the custom data. |
| ...CustomDataDetails.type | No | String | The type of the custom data. |
| ...CustomDataDetails.value | Yes | String | The value of the custom data. |
| accountDetails.email | Yes | String | The email of the user. |
| accountDetails.firstName | No | String | The first name of the user. |
| accountDetails.lastName | No | String | The last name of the user. |
| accountDetails.gender | No | String | The gender of the user. |
| accountDetails.language | Yes | String | The language of the user. |
| accountDetails.lastLoginDate | No | String | The last login data of the user. |
| accountDetails.nickname | Yes | String | The username of the user. |
| accountDetails.supportEmail | No | String | |
| accountDetails.termsAccepted | No | Boolean | Whether the terms and conditions |
| | | | have been accepted by the user. |
| accountDetails.timeZoneIdentifier | No | String | The time zone of the user. |

b. modifyAccountResponse

| | | | |
|---|---|---|---|
| return | Yes | String | The account ID of the account |
| | | | updated |

TABLE 7

| | | | |
|---|---|---|---|
| Parameter | Req'd? | Type | Description |

a. modifyAddressDetails

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| accountId | Yes | String | The ID of the account that owns the |
| | | | address. |
| addressDetails | No | Object | The list of addresses in the consumer |
| | | | account to modify. |
| addressDetails.AddressDetails | Yes | Object | The locale of the user. The available |
| | | | locales are configured for your |
| | | | application during setup. |
| ...AddressDetails.active | Yes | Boolean | Whether the account is currently |
| | | | active. |
| ...AddressDetails.addressDetailId | Yes | String | A unique identifier for the address. |
| ...AddressDetails.addressStatus | No | String | An optional address status that can |
| | | | be used to track the external status of |
| | | | the address. |
| ...AddressDetails.city | Yes | String | The city of the address. |
| ...AddressDetails.company | No | String | The company name of the address. |
| ...AddressDetails.countryCode | No | String | |
| ...AddressDetails.countryIsoCode | No | String | The ISO country code of the address. |
| ...AddressDetails.defaultBilling | Yes | Boolean | Whether the address should be the |
| | | | consumer's default billing address. |
| ...AddressDetails.defaultShipping | Yes | Boolean | Whether the address should be the |
| | | | consumer's default shipping address. |
| ...AddressDetails.email | No | String | The email associated with the |
| | | | address. |
| ...AddressDetails.firstName | No | String | The first name associated with the |
| | | | address. |
| ...AddressDetails.lastName | No | String | The last name associated with the |
| | | | address. |
| ...AddressDetails.phone | No | String | The phone number associated with |
| | | | the address. |
| ...AddressDetails.stateCode | Yes | String | The state code of the address. |
| ...AddressDetails.street1 | Yes | String | The first line of the street address. |
| ...AddressDetails.street2 | Yes | String | The second line of the street |
| | | | address. |
| ...AddressDetails.type | Yes | String | An arbitrary string identifying the |
| | | | address. (E.g., “Home” or “Work”). |
| ...AddressDetails.validFrom | No | Date | The start date after which the |
| | | | address should be considered valid. |
| ...AddressDetails.zipCode | Yes | String | The zip code of the address. |

b. modifyAddressDetailsResponse

| | | | |
|---|---|---|---|
| return | Yes | String | The ID of the account whose |
| | | | addresses have been modified. |

TABLE 8

| | | | |
|---|---|---|---|
| Parameter | Req'd? | Type | Description |

a. modifyCustomDataDetails

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| accountId | Yes | String | The ID of the account to be updated. |
| customDataDetails | No | Object | A set of custom data elements to be |
| | | | modified for the account. |
| customDataDetails.CustomDataDetails | Yes | Object | A custom data element. |
| ...CustomDataDetails.freeKey | Yes | String | The key for the custom data. |
| ...CustomDataDetails.type | No | String | The type of the custom data. |
| ...CustomDataDetails.value | Yes | String | The value of the custom data. |

b. modifyAccountResponse

| | | | |
|---|---|---|---|
| return | Yes | String | The account ID of the account |
| | | | updated. |

TABLE 9

| | | | |
|---|---|---|---|
| Parameter | Req'd? | Type | Description |

a. updateIdentity

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| identityDetails | Yes | Object | A block of identity details. |
| identityDetails.accountId | Yes | String | The ID of the account this identity |
| | | | should be associated with. |
| identityDetails.attributeValues | No | Object | A set of attribute values associated |
| | | | with the identity. |
| | | | Attributes (below) should be used |
| | | | when the attribute is merely a flag on |
| | | | the account (i.e., Is Premium |
| | | | Subscriber). |
| ...attributeValues.AttributeValue | Yes | Object | An attribute value to be associated |
| | | | with the identity. |
| ...AttributeValue.attributeValueType | Yes | String | The type of the attribute value. |
| ...AttributeValue.customText | Yes | String | The value to be applied to the |
| | | | attribute. |
| ...AttributeValue.inGameId | Yes | String | The in-game identifier of the attribute. |
| ...AttributeValue.name | Yes | String | The name of the attribute. |
| identityDetails.attributes | No | Object | A set of attributes associated with the |
| | | | identity. |
| | | | Attribute Values (above) should be |
| | | | used when the identity has a |
| | | | configured value (i.e., Character |
| | | | Level = 5). |
| ...attributes.Attribute | Yes | Object | An attribute associated with the |
| | | | identity. |
| ...Attribute.inGameId | Yes | String | The in-game identifier of the attribute. |
| ...Attribute.name | Yes | String | The name of the attribute. |
| identityDetails.gameIdentifier | Yes | String | The identifier of the game this identity |
| | | | should be associated with. Valid |
| | | | game identifiers are configured |
| | | | during setup. |
| identityDetails.identityDetailsId | Yes | String | A unique identifier for the identity. |
| identityDetails.inGameId | Yes | String | The in-game identifier of the identity. |
| | | | Commonly the character name or the |
| | | | internal ID in your game engine. |
| identityDetails.name | Yes | String | The name of the identity. |

b. updateIdentityResponse

| | | | |
|---|---|---|---|
| return | Yes | String | The ID of the account |
| | | | modified. |

TABLE 10

| | | | |
|---|---|---|---|
| Parameter | Req'd? | Type | Description |

a. deleteAccount

| | | | |
|---|---|---|---|
| Key | Yes | Object | Encapsulates security token |
| | | | information. |
| key.accountId | No | String | The FFG account ID of the |
| | | | system account making the |
| | | | call. |
| key.ip | No | String | The IP address of the system |
| | | | making the call. |
| key.key | Yes | String | A pre-configured credential |
| | | | used to authenticate the |
| | | | caller. |
| key.uuid | No | String | Unique identifier of the |
| | | | request. If provided, |
| | | | subsequent requests with the |
| | | | same UUID should be |
| | | | ignored. |
| accountId | Yes | String | The ID of the account to be |
| | | | deleted. |

b. deleteAccountResponse

| | | | |
|---|---|---|---|
| Return | Yes | String | The ID of the account |
| | | | deleted. |

TABLE 11

| | | | |
|---|---|---|---|
| Parameter | Req'd? | Type | Description |

a. deleteIdentity

| | | | |
|---|---|---|---|
| Key | Yes | Object | Encapsulates |
| | | | security token |
| | | | information. |
| key.accountId | No | String | The FFG |
| | | | account ID |
| | | | of the system |
| | | | account |
| | | | making the call. |
| key.ip | No | String | The IP address |
| | | | of the system |
| | | | making the call. |
| key.key | Yes | String | A pre-configured |
| | | | credential used to |
| | | | authenticate the |
| | | | caller. |
| key.uuid | No | String | Unique identifier |
| | | | of the request. |
| | | | If provided, |
| | | | subsequent requests |
| | | | with the same UUID |
| | | | should be ignored. |
| identityDetails.accountId | Yes | String | The ID of the |
| | | | account whose |
| | | | identity should be |
| | | | deleted. |
| identityDetails.identityDetailsId | Yes | String | The ID of the |
| | | | identity to be |
| | | | deleted. |

b. deleteIdentityResponse

| | | | |
|---|---|---|---|
| return | Yes | String | The ID of the |
| | | | identity deleted. |

TABLE 12

| | | | |
|---|---|---|---|
| Parameter | Req'd? | Type | Description |

a. getAccountDetails

| | | | |
|---|---|---|---|
| key | Yes | Object | Encapsulates security token |
| | | | information. |
| key.accountId | No | String | The FFG account ID of the |
| | | | system account making the call. |
| key.ip | No | String | The IP address of the system |
| | | | making the call. |
| key.key | Yes | String | A pre-configured credential |
| | | | used to authenticate the caller. |
| key.uuid | No | String | Unique identifier of the request. |
| | | | If provided, subsequent |
| | | | requests with the same UUID |
| | | | should be ignored. |
| accountId | Yes | String | The ID of the account to |
| | | | retrieve. |

b. getAccountDetailsResponse

| | | | |
|---|---|---|---|
| accountId | Yes | String | A unique identifier for the |
| | | | account. |
| addresses | No | Object | The list of addresses in the |
| | | | consumer account. |
| addresses.AddressDetails | Yes | Object | The details for an address. |
| ...AddressDetails.active | Yes | Boolean | Whether the account is currently |
| | | | active. |
| ...AddressDetails.addressDetailId | Yes | String | A unique identifier for the |
| | | | address. |
| ...AddressDetails.addressStatus | No | String | An optional address status that |
| | | | can be used to track the external |
| | | | status of the address. |
| ...AddressDetails.city | Yes | String | The city of the address. |
| ...AddressDetails.company | No | String | The company name of the |
| | | | address. |
| ...AddressDetails.countryCode | No | String | |
| ...AddressDetails.countryIsoCode | No | String | The ISO country code of the |
| | | | address. |
| ...AddressDetails.defaultBilling | Yes | Boolean | Whether the address should be |
| | | | the consumer's default billing |
| | | | address. |
| ...AddressDetails.defaultShipping | Yes | Boolean | Whether the address should be |
| | | | the consumer's default shipping |
| | | | address. |
| ...AddressDetails.email | No | String | The email associated with the |
| | | | address. |
| ...AddressDetails.firstName | No | String | The first name associated with |
| | | | the address. |
| ...AddressDetails.lastName | No | String | The last name associated with |
| | | | the address. |
| ...AddressDetails.phone | No | String | The phone number associated |
| | | | with the address. |
| ...AddressDetails.stateCode | Yes | String | The state code of the address. |
| ...AddressDetails.street1 | Yes | String | The first line of the street |
| | | | address. |
| ...AddressDetails.street2 | Yes | String | The second line of the street |
| | | | address. |
| ...AddressDetails.type | Yes | String | An arbitrary string identifying the |
| | | | address. (E.g., “Home” or |
| | | | “Work”). |
| ...AddressDetails.validFrom | No | Date | The start date after which the |
| | | | address should be considered |
| | | | valid. |
| ...AddressDetails.zipCode | Yes | String | The zip code of the address. |
| birthday | No | Date | The birthday of the user. |
| childAccountRestrictionData | No | Object | Account restrictions applied to |
| | | | child accounts related to this |
| | | | account. |
| companyName | No | String | The company name of the |
| | | | account. |
| creationDate | No | Date | The creation date of the account. |
| customData | No | Object | A set of custom data elements to |
| | | | be stored for the account. |
| customData.CustomDataDetails | Yes | Object | A custom data element. |
| ...CustomDataDetails.freeKey | Yes | String | The key for the custom data. |
| ...CustomDataDetails.type | No | String | The type of the custom data. |
| ...CustomDataDetails.value | Yes | String | The value of the custom data. |
| email | Yes | String | The email of the user. |
| firstName | No | String | The first name of the user. |
| lastName | No | String | The last name of the user. |
| gender | No | String | The gender of the user. |
| language | Yes | String | The language of the user. |
| lastLoginDate | No | String | The last login data of the user. |
| nickname | Yes | String | The username of the user. |
| supportEmail | No | String | |
| termsAccepted | No | Boolean | Whether the terms and |
| | | | conditions have been accepted |
| | | | by the user. |
| timeZoneIdentifier | No | String | The time zone of the user. |

TABLE 13

| | | | |
|---|---|---|---|
| Parameter | Req'd? | Type | Description |

a. findAccount

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| searchParams | No | Object | General search parameters. |
| searchParams.accountId | No | String | The account ID to search within. |
| searchParams.ascending | No | Boolean | Whether the results should be |
| | | | returned in ascending alphabetical |
| | | | order. |
| searchParams.count | No | Integer | The number of results to be returned. |
| | | | Used with “from” can be used to |
| | | | implement pagination. |
| searchParams.from | No | Integer | The start position from which the |
| | | | results should be returned. Used |
| | | | with “count” can be used to |
| | | | implement pagination. |
| searchParams.gameIdentifier | No | String | The Game identifier to search within. |
| search Params.identityId | No | String | The identity to search within. |
| searchParams.locale | No | String | The locale to search within. |
| searchParams.searchOrder | No | String | The search order the results should |
| | | | be returned. |
| accountSearchParams | No | Object | Account-specific search parameters. |
| accountSearchParams.gameIdentifier | No | String | The Game identifier to search within. |
| accountSearchParams.identityName | No | String | The name of an identity to find the |
| | | | account for. |
| accountSearchParams.name | No | String | The name of the account to be found. |

b. findAccountResponse

| | | | |
|---|---|---|---|
| accounts | Yes | Object | A set of accounts that match the |
| | | | search parameters. |
| accounts.Account | No | Object | An account result. |
| ...Account.accountId | Yes | String | The ID of the account. |
| ...Account.email | Yes | String | The email address of the account. |
| ...Account.language | Yes | String | The language code of the account. |
| ...Account.nickname | Yes | String | The nickname of the account. |
| count | Yes | Integer | The number of results returned in |
| | | | this response. |
| countTotal | Yes | Integer | The total number of results for this |
| | | | search. |
| from | Yes | Integer | The start index of the returned |
| | | | results. |

TABLE 14

| | | | |
|---|---|---|---|
| Parameter | Req'd? | Type | Description |

a. getIdentity

| | | | |
|---|---|---|---|
| Key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| identityId | Yes | String | The ID of the identity to retrieve. |

b. getIdentityResponse

| | | | |
|---|---|---|---|
| accountId | Yes | String | The ID of the account this identity |
| | | | should be associated with. |
| attributeValues | No | Object | A set of attribute values associated |
| | | | with the identity. |
| | | | Attributes (below) should be used |
| | | | when the attribute is merely a flag on |
| | | | the account (i.e., Is Premium |
| | | | Subscriber). |
| ...attributeValues.AttributeValue | Yes | Object | An attribute value to be associated |
| | | | with the identity. |
| ...AttributeValue.attributeValueType | Yes | String | The type of the attribute value. |
| ...AttributeValue.customText | Yes | String | The value to be applied to the |
| | | | attribute. |
| ...AttributeValue.inGameId | Yes | String | The in-game identifier of the attribute. |
| ...AttributeValue.name | Yes | String | The name of the attribute. |
| attributes | No | Object | A set of attributes associated with the |
| | | | identity. |
| | | | Attribute Values (above) should be |
| | | | used when the identity has a |
| | | | configured value (i.e., Character |
| | | | Level = 5). |
| ...attributes.Attribute | Yes | Object | An attribute associated with the |
| | | | identity. |
| ...Attribute.inGameId | Yes | String | The in-game identifier of the attribute. |
| ...Attribute.name | Yes | String | The name of the attribute. |
| gameIdentifier | Yes | String | The identifier of the game this identity |
| | | | should be associated with. Valid |
| | | | game identifiers are configured |
| | | | during setup. |
| identityDetailsId | Yes | String | A unique identifier for the identity. |
| inGameId | Yes | String | The in-game identifier of the identity. |
| | | | Commonly the character name or the |
| | | | internal ID in your game engine. |
| name | Yes | String | The name of the identity. |

TABLE 15

| | | | |
|---|---|---|---|
| Parameter | Req'd? | Type | Description |

a. getIdentities

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| accountId | Yes | String | The ID of the account whose |
| | | | identities should be retrieved. |

b. getIdentitiesResponse

| | | | |
|---|---|---|---|
| IdentityDetails | No | Object | An identity associated with the |
| | | | searched for account. |
| IdentityDetails.accountId | Yes | String | The ID of the account this identity |
| | | | should be associated with. |
| IdentityDetails.attributeValues | No | Object | A set of attribute values associated |
| | | | with the identity. |
| | | | Attributes (below) should be used |
| | | | when the attribute is merely a flag |
| | | | on the account (i.e., Is Premium |
| | | | Subscriber). |
| ...attributeValues.AttributeValue | Yes | Object | An attribute value to be associated |
| | | | with the identity. |
| ...AttributeValue.attributeValueType | Yes | String | The type of the attribute value. |
| ...AttributeValue.customText | Yes | String | The value to be applied to the |
| | | | attribute. |
| ...AttributeValue.inGameId | Yes | String | The in-game identifier of the |
| | | | attribute. |
| ...AttributeValue.name | Yes | String | The name of the attribute. |
| IdentityDetails.attributes | No | Object | A set of attributes associated with |
| | | | the identity. |
| | | | Attribute Values (above) should be |
| | | | used when the identity has a |
| | | | configured value (i.e., Character |
| | | | Level = 5). |
| ...attributes.Attribute | Yes | Object | An attribute associated with the |
| | | | identity. |
| ...Attribute.inGameId | Yes | String | The in-game identifier of the |
| | | | attribute. |
| ...Attribute.name | Yes | String | The name of the attribute. |
| IdentityDetails.gameIdentifier | Yes | String | The identifier of the game this |
| | | | identity should be associated with. |
| | | | Valid game identifiers are |
| | | | configured during setup. |
| IdentityDetails.identityDetailsId | Yes | String | A unique identifier for the identity. |
| IdentityDetails.inGameId | Yes | String | The in-game identifier of the |
| | | | identity. Commonly the character |
| | | | name or the internal ID in your |
| | | | game engine. |
| IdentityDetails.name | Yes | String | The name of the identity. |

TABLE 16

| | | | |
|---|---|---|---|
| Parameter | Req'd? | Type | Description |

a. getSubscriptionDetails

| | | | |
|---|---|---|---|
| key | Yes | Object | Encapsulates |
| | | | security token |
| | | | information. |
| key.accountId | No | String | The FFG account ID |
| | | | of the system account |
| | | | making the call. |
| key.ip | No | String | The IP address of |
| | | | the system making |
| | | | the call. |
| key.key | Yes | String | A pre-configured |
| | | | credential used to |
| | | | authenticate the caller. |
| key.uuid | No | String | Unique identifier of |
| | | | the request. If |
| | | | provided, subsequent |
| | | | requests with the |
| | | | same UUID should be |
| | | | ignored. |
| subscriptionParams | Yes | Object | The set of account |
| | | | and identity details to |
| | | | find subscriptions for. |
| subscriptionParams.accountId | Yes | String | The account ID to |
| | | | retrieve subscriptions |
| | | | for. |
| subscriptionParams.identityId | Yes | String | The identity ID to |
| | | | retrieve subscriptions |
| | | | for. |

b. getSubscriptionDetailsResponse

| | | | |
|---|---|---|---|
| endDate | No | Object | The end date of the |
| | | | subscription. |
| internalName | Yes | String | The name of the |
| | | | subscription. |
| startDate | No | Object | The start date of the |
| | | | subscription. |

TABLE 17

| | | | |
|---|---|---|---|
| Parameter | Req'd? | Type | Description |

a. findIdentity

| | | | |
|---|---|---|---|
| Key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| searchParams | No | Object | General search parameters. |
| searchParams.accountId | No | String | The account ID to search within. |
| searchParams.ascending | No | Boolean | Whether the results should be |
| | | | returned in ascending alphabetical |
| | | | order. |
| searchParams.count | No | Integer | The number of results to be |
| | | | returned. Used with “from” can be |
| | | | used to implement pagination. |
| searchParams.from | No | Integer | The start position from which the |
| | | | results should be returned. Used |
| | | | with “count” can be used to |
| | | | implement pagination. |
| searchParams.gameIdentifier | No | String | The Game identifier to search |
| | | | within. |
| searchParams.identityId | No | String | The identity to search within. |
| searchParams.locale | No | String | The locale to search within. |
| searchParams.searchOrder | No | String | The search order the results should |
| | | | be returned. |
| identitySearchParams | No | Object | Account-specific search |
| | | | parameters. |
| identitySearchParams.accountId | No | String | The account ID to search within. |
| identitySearchParams.attributes | No | Object | A set of attributes to search for. |
| ...attributes.string | No | String | The name of an attribute to search |
| | | | for. |
| identitySearchParams.gameIdentifier | No | String | The Game identifier to search |
| | | | within. |
| accountSearchParams.name | No | String | The name of the identity to be |
| | | | found. |

b. findIdentityResponse

| | | | |
|---|---|---|---|
| Count | Yes | Integer | The number of results returned in |
| | | | this response. |
| countTotal | Yes | Integer | The total number of results for this |
| | | | search. |
| From | Yes | Integer | The start index of the returned |
| | | | results. |
| Identities | Yes | Object | The set of identities that match the |
| | | | search parameters. |
| Identities.IdentityDetails | No | Object | An identity result. |
| ...IdentityDetails.accountId | Yes | String | The ID of the account this identity |
| | | | should be associated with. |
| ...IdentityDetails.attributeValues | No | Object | A set of attribute values associated |
| | | | with the identity. |
| | | | Attributes (below) should be used |
| | | | when the attribute is merely a flag |
| | | | on the account (i.e., Is Premium |
| | | | Subscriber). |
| ...attributeValues.AttributeValue | Yes | Object | An attribute value to be associated |
| | | | with the identity. |
| ...AttributeValue.attributeValueType | Yes | String | The type of the attribute value. |
| ...AttributeValue.customText | Yes | String | The value to be applied to the |
| | | | attribute. |
| ...AttributeValue.inGameId | Yes | String | The in-game identifier of the |
| | | | attribute. |
| ...AttributeValue.name | Yes | String | The name of the attribute. |
| ...IdentityDetails.attributes | No | Object | A set of attributes associated with |
| | | | the identity. |
| | | | Attribute Values (above) should be |
| | | | used when the identity has a |
| | | | configured value (i.e., Character |
| | | | Level = 5). |
| ...attributes.Attribute | Yes | Object | An attribute associated with the |
| | | | identity. |
| ...Attribute.inGameId | Yes | String | The in-game identifier of the |
| | | | attribute. |
| ...Attribute.name | Yes | String | The name of the attribute. |
| ...IdentityDetails.gameIdentifier | Yes | String | The identifier of the game this |
| | | | identity should be associated with. |
| | | | Valid game identifiers are |
| | | | configured during setup. |
| ...IdentityDetails.identityDetailsId | Yes | String | A unique identifier for the identity. |
| ...IdentityDetails.inGameId | Yes | String | The in-game identifier of the |
| | | | identity. Commonly the character |
| | | | name or the internal ID in your |
| | | | game engine. |
| ...IdentityDetails.name | Yes | String | The name of the identity. |

TABLE 18

| | | | |
|---|---|---|---|
| Parameter | Req'd? | Type | Description |

a. login

| | | | |
|---|---|---|---|
| Key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| Nickname | Yes | String | The nickname of the account to be |
| | | | logged in. |
| password | Yes | String | The password of the account to be |
| | | | logged in. |
| locale | Yes | String | The locale to be used for the login. |
| ip | No | String | The IP address of the user logging |
| | | | in. |
| client | No | String | A freeform keyword indicating the |
| | | | type of client used for the login. |
| | | | (E.g., “Web” or “Java Client”.) |

b. loginResponse

| | | | |
|---|---|---|---|
| accountId | Yes | String | The ID of the account logged in. |
| name | Yes | String | The name of the account logged in. |
| nickname | Yes | String | The nickname of the account |
| | | | logged in. |
| session | Yes | String | A session ID identifying the user's |
| | | | login session. |

TABLE 19

| | | | |
|---|---|---|---|
| Parameter | Req'd? | Type | Description |

a. logout

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| nickname | Yes | String | The nickname of the user to be |
| | | | logged out. |
| sessionId | Yes | String | The session ID passed in the initial |
| | | | login request. |

b. logoutResponse

| | | | |
|---|---|---|---|
| callResult | Yes | Enum | “SUCCESS” or “ERROR” |

TABLE 20

| | | | |
|---|---|---|---|
| Parameter | Req'd? | Type | Description |

a. handshake

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| handshakeParams | Yes | Object | The handshake parameters. |
| handshakeParams.accountId | | | The Account ID of the user. |
| handshakeParams.name | Yes | String | The name of the user. |
| handshakeParams.sessionId | Yes | String | The Session ID retrieved from a |
| | | | prior call to the “login” method of |
| | | | the Account Service. |

b. handshakeResponse

| | | | |
|---|---|---|---|
| accountId | Yes | String | The Account ID of the user logged in. |
| name | Yes | String | The name of the user. |
| token | Yes | String | The token to be passed to the FFG |
| | | | web application. |

An inventory service 338 is used to manage the items owned by an account's identities. Inventory may be automatically tracked for purchases made through the storefront services 308 of a preferred embodiment. Inventory services 338 may be provided for inventory synchronization in cases where inventory needs to be adjusted due to actions not otherwise visible to the in-game e-commerce system platform. The inventory methods within the inventory web service 338 are listed in Table 21 and described in Tables 22-23.

TABLE 21
Inventory Services Methods

| Method | Description |
|---|---|
| addItem | Adds an item to an identity's inventory |
| deleteItem | Removes an item from an identity's inventory |

TABLE 22

| | | | |
|---|---|---|---|
| Parameter | Req'd? | Type | Description |

a. addItem

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with the |
| | | | same UUID should be ignored. |
| inventoryItem | Yes | Object | The item to be added. |
| inventoryItem.accountId | Yes | String | The Account ID of the user to receive |
| | | | the item. |
| inventoryItem.gameIdentifier | Yes | String | The Game ID of the application |
| | | | affected. |
| inventoryItem.identityId | Yes | String | The Identity ID of the user's identity to |
| | | | receive the item. |
| inventoryItem.inGameId | Yes | String | The In-Game ID of the item to be |
| | | | received. |
| inventoryItem.quantity | Yes | Integer | The quantity of items to be received. |

b. addItemResponse

| | | | |
|---|---|---|---|
| callResult | Yes | Enum | “SUCCESS” or “ERROR” |

TABLE 23

| | | | |
|---|---|---|---|
| Parameter | Req'd? | Type | Description |

a. deleteItem

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with the |
| | | | same UUID should be ignored. |
| inventoryItem | Yes | Object | The item to be removed. |
| inventoryItem.accountId | Yes | String | The Account ID of the user to lose the |
| | | | item. |
| inventoryItem.gameIdentifier | Yes | String | The Game ID of the application |
| | | | affected. |
| inventoryItem.identityId | Yes | String | The Identity ID of the user's identity to |
| | | | lose the item. |
| inventoryItem.inGameId | Yes | String | The In-Game ID of the item to be |
| | | | removed. |
| inventoryItem.quantity | Yes | Integer | The quantity of items to be removed. |

b. deleteItemResponse

| | | | |
|---|---|---|---|
| callResult | Yes | Enum | “SUCCESS” or “ERROR” |

The Wallet Service 340 is used to directly manage a user's wallet balances. The wallet balance is updated whenever a purchase is made using the storefront web services 308. This service 340 is used for when you wish to directly manage a customer's balances. For example, to provide bonus points for referring a friend. SSL is required by the interface unless some other network level encryption or private connection is in place. The wallet methods within the wallet web service 340 are listed in Table 24 and described in Tables 25-30.

TABLE 24
Wallet Services Methods

| Method | Description |
|---|---|
| creditWallet | Adds balance to a user's wallet |
| creditWallets | Bulk version of the Credit Wallet method suitable |
| | for performing batch wallet credits |
| debitWallet | Deduct balance from a user's wallet |
| debitWallets | Bulk version of the Debit Wallet method suitable |
| | for performing batch wallet debits |
| getAmountDecimal | Retrieves a consumer's wallet balance |
| findWalletTransaction | Searches for wallet transactions |

TABLE 25

| | | | |
|---|---|---|---|
| Parameter | Req'd? | Type | Description |

a. creditWallet

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| gwalletTransaction | Yes | Object | The transaction. |
| gwalletTransaction.accountId | Yes | String | The Account ID of the user to receive |
| | | | the balance. |
| gwalletTransaction.amount | No | Integer | The amount to be credited. |
| | | | Only one of “amount” or |
| | | | “amountDecimal” should be used. |
| gwalletTransaction.currencyIdentifier | Yes | String | The currency to be deposited. |
| gwalletTransaction.decimalAmount | No | Decimal | The amount to be credited. |
| | | | Only one of “amount” or |
| | | | “amountDecimal” should be used. |
| gwalletTransaction.gameIdentifier | Yes | String | The Game ID affected. |
| gwalletTransaction.identityId | Yes | String | The identity that should receive the |
| | | | credit. |
| gwalletTransaction.messageKey | No | String | An optional message key to a |
| | | | templated message shown to the |
| | | | user in their transaction history. |
| gwalletTransaction.messageParameters | No | Object | The set of parameters to be inserted |
| | | | in the templated message. |
| ...messageParameters.entry | No | Object | A message key/value pair. |
| ...entry.key | Yes | String | The key to be replaced. |
| ...entry.value | Yes | String | The value to be inserted. |
| gwalletTransaction.requestParameters | No | Object | Optional set of request parameters to |
| | | | be stored for the transaction. |
| ...requestParameters.entry | No | Object | A request key/value pair. |
| ...entry.key | Yes | String | The key of the request parameter. |
| ...entry.value | Yes | String | The value of the request parameter. |
| gwalletTransaction.transactionDetailId | Yes | String | A unique identifier for the transaction. |
| gwalletTransaction.walletTrxTypeEnum | Yes | Enum | One of “transaction”, “external”, |
| | | | “settlement”, “cancel”, |
| | | | “partialSettlement”, “partialCancel”, |
| | | | “auction”, “reserved”, |
| | | | “lifetimeExpired”, “chargeback”, |
| | | | “partial”, “reverse_auction” or |
| | | | “refund”. |

a. creditWalletResponse

| | | | |
|---|---|---|---|
| Return | Yes | String | The transaction detail ID. |

TABLE 26

| | | | |
|---|---|---|---|
| Parameter | Req'd? | Type | Description |

a. creditWallets

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| gwalletTransactions | Yes | Object | The set of transactions to be |
| | | | processed. |
| gwalletTransactions.GwalletTransaction | Yes | Object | A transaction to be processed. |
| ...GwalletTransaction.accountId | Yes | String | The Account ID of the user to receive |
| | | | the balance. |
| ...GwalletTransaction.amount | No | Integer | The amount to be credited. |
| | | | Only one of “amount” or |
| | | | “amountDecimal” should be used. |
| ...GwalletTransaction.currencyIdentifier | Yes | String | The currency to be deposited. |
| ...GwalletTransaction.decimalAmount | No | Decimal | The amount to be credited. |
| | | | Only one of “amount” or |
| | | | “amountDecimal” should be used. |
| ...GwalletTransaction.gameIdentifier | Yes | String | The Game ID affected. |
| ...GwalletTransaction.identityId | Yes | String | The identity that should receive the |
| | | | credit. |
| ...GwalletTransaction.messageKey | No | String | An optional message key to a |
| | | | templated message shown to the |
| | | | user in their transaction history. |
| ...GwalletTransaction.messageParameters | No | Object | The set of parameters to be inserted |
| | | | in the templated message. |
| ...messageParameters.entry | No | Object | A message key/value pair. |
| ...entry.key | Yes | String | The key to be replaced. |
| ...entry.value | Yes | String | The value to be inserted. |
| ...GwalletTransaction.requestParameters | No | Object | Optional set of request parameters to |
| | | | be stored for the transaction. |
| ...requestParameters.entry | No | Object | A request key/value pair. |
| ...entry.key | Yes | String | The key of the request parameter. |
| ...entry.value | Yes | String | The value of the request parameter. |
| ...GwalletTransaction.transactionDetailId | Yes | String | A unique identifier for the transaction. |
| ...GwalletTransaction.walletTrxTypeEnum | Yes | Enum | One of “transaction”, “external”, |
| | | | “settlement”, “cancel”, |
| | | | “partialSettlement”, “partialCancel”, |
| | | | “auction”, “reserved”, |
| | | | “lifetimeExpired”, “chargeback”, |
| | | | “partial”, “reverse_auction” or |
| | | | “refund”. |

b. creditWalletsResponse

| | | | |
|---|---|---|---|
| return | Yes | Object | The set of return values. |
| return.string | Yes | String | The transaction detail ID of the processed |
| | | | request. |

TABLE 27

| | | | |
|---|---|---|---|
| Parameter | Req'd? | Type | Description |

a. debitWallet

| | | | |
|---|---|---|---|
| key | Yes | Object | Encapsulates security token information. |
| key.accountId | No | String | The FFG account ID of the system account |
| | | | making the call. |
| key.ip | No | String | The IP address of the system making the |
| | | | call. |
| key.key | Yes | String | A pre-configured credential used to |
| | | | authenticate the caller. |
| key.uuid | No | String | Unique identifier of the request. If |
| | | | provided, subsequent requests with the |
| | | | same UUID should be ignored. |
| gwalletTransaction | Yes | Object | The transaction. |
| gwalletTransaction.accountId | Yes | String | The Account ID of the user to lose the |
| | | | balance. |
| gwalletTransaction.amount | No | Integer | The amount to be debited. |
| | | | Only one of “amount” or “amountDecimal” |
| | | | should be used. |
| gwalletTransaction.currencyIdentifier | Yes | String | The currency to be debited. |
| gwalletTransaction.decimalAmount | No | Decimal | The amount to be debited. |
| | | | Only one of “amount” or “amountDecimal” |
| | | | should be used. |
| gwalletTransaction.gameIdentifier | Yes | String | The Game ID affected. |
| gwalletTransaction.identityId | Yes | String | The identity that should receive the debit. |
| gwalletTransaction.messageKey | No | String | An optional message key to a templated |
| | | | message shown to the user in their |
| | | | transaction history. |
| gwalletTransaction.messageParameters | No | Object | The set of parameters to be inserted in the |
| | | | templated message. |
| ...messageParameters.entry | No | Object | A message key/value pair. |
| ...entry.key | Yes | String | The key to be replaced. |
| ...entry.value | Yes | String | The value to be inserted. |
| gwalletTransaction.requestParameters | No | Object | Optional set of request parameters to be |
| | | | stored for the transaction. |
| ...requestParameters.entry | No | Object | A request key/value pair. |
| ...entry.key | Yes | String | The key of the request parameter. |
| ...entry.value | Yes | String | The value of the request parameter. |
| gwalletTransaction.transactionDetailId | Yes | String | A unique identifier for the transaction. |
| gwalletTransaction.walletTrxTypeEnum | Yes | Enum | One of “transaction”, “external”, |
| | | | “settlement”, “cancel”, “partialSettlement”, |
| | | | “partialCancel”, “auction”, “reserved”, |
| | | | “lifetimeExpired”, “chargeback”, “partial”, |
| | | | “reverse_auction” or “refund”. |

b. debitWalletResponse

| | | | |
|---|---|---|---|
| Return | Yes | String | The transaction detail ID. |

TABLE 28

| | | | |
|---|---|---|---|
| Parameter | Req'd? | Type | Description |

a. debitWallets

| | | | |
|---|---|---|---|
| key | Yes | Object | Encapsulates security token information. |
| key.accountId | No | String | The FFG account ID of the system |
| | | | account making the call. |
| key.ip | No | String | The IP address of the system making the |
| | | | call. |
| key.key | Yes | String | A pre-configured credential used to |
| | | | authenticate the caller. |
| key.uuid | No | String | Unique identifier of the request. If |
| | | | provided, subsequent requests with the |
| | | | same UUID should be ignored. |
| gwalletTransactions | Yes | Object | The set of transactions to be processed. |
| gwalletTransactions.GwalletTransaction | Yes | Object | A transaction to be processed. |
| ...GwalletTransaction.accountId | Yes | String | The Account ID of the user to receive the |
| | | | balance. |
| ...GwalletTransaction.amount | No | Integer | The amount to be credited. |
| | | | Only one of “amount” or “amountDecimal” |
| | | | should be used. |
| ...GwalletTransaction.currencyIdentifier | Yes | String | The currency to be deposited. |
| ...GwalletTransaction.decimalAmount | No | Decimal | The amount to be credited. |
| | | | Only one of “amount” or “amountDecimal” |
| | | | should be used. |
| ...GwalletTransaction.gameIdentifier | Yes | String | The Game ID affected. |
| ...GwalletTransaction.identityId | Yes | String | The identity that should receive the credit. |
| ...GwalletTransaction.messageKey | No | String | An optional message key to a templated |
| | | | message shown to the user in their |
| | | | transaction history. |
| ...GwalletTransaction.messageParameters | No | Object | The set of parameters to be inserted in |
| | | | the templated message. |
| ...messageParameters.entry | No | Object | A message key/value pair. |
| ...entry.key | Yes | String | The key to be replaced. |
| ...entry.value | Yes | String | The value to be inserted. |
| ...GwalletTransaction.requestParameters | No | Object | Optional set of request parameters to be |
| | | | stored for the transaction. |
| ...requestParameters.entry | No | Object | A request key/value pair. |
| ...entry.key | Yes | String | The key of the request parameter. |
| ...entry.value | Yes | String | The value of the request parameter. |
| ...GwalletTransaction.transactionDetailId | Yes | String | A unique identifier for the transaction. |
| ...GwalletTransaction.walletTrxTypeEnum | Yes | Enum | One of “transaction”, “external”, |
| | | | “settlement”, “cancel”, “partialSettlement”, |
| | | | “partialCancel”, “auction”, “reserved”, |
| | | | “lifetimeExpired”, “chargeback”, “partial”, |
| | | | “reverse_auction” or “refund”. |

b. loginResponse

| | | | |
|---|---|---|---|
| return | Yes | Object | The set of return values. |
| return.string | Yes | String | The transaction detail ID of the processed |
| | | | request. |

TABLE 29

| | | | |
|---|---|---|---|
| Parameter | Req'd? | Type | Description |

a. getAmountDecimal

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be |
| | | | ignored. |
| accountId | Yes | String | The Account ID. |
| identityId | Yes | String | The Identity ID. |
| currencyIdentifier | Yes | String | The Currency ID. |
| gameIdentifier | Yes | String | The Game ID. |

b. getAmountDecimalResponse

| | | | |
|---|---|---|---|
| decimalAmount | Yes | Decimal | The current balance of the |
| | | | consumer's account. |

TABLE 30

| | | | |
|---|---|---|---|
| Parameter | Req'd? | Type | Description |

a. findWalletTransaction

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| searchParams | No | Object | General search parameters. |
| searchParams.accountId | No | String | The account ID to search within. |
| searchParams.ascending | No | Boolean | Whether the results should be |
| | | | returned in ascending alphabetical |
| | | | order. |
| searchParams.count | No | Integer | The number of results to be |
| | | | returned. Used with “from” can be |
| | | | used to implement pagination. |
| searchParams.from | No | Integer | The start position from which the |
| | | | results should be returned. Used |
| | | | with “count” can be used to |
| | | | implement pagination. |
| searchParams.gameIdentifier | No | String | The Game identifier to search |
| | | | within. |
| searchParams.identityId | No | String | The identity to search within. |
| searchParams.locale | No | String | The locale to search within. |
| searchParams.searchOrder | No | String | The search order the results should |
| | | | be returned. |
| walletTransactionSearchParams | No | Object | The wallet transaction specific |
| | | | search params. |
| ...associatedAccountId | No | String | The account ID to search under. |
| ...currencyIdentifier | No | String | The currency ID to be searched for. |
| ...transactionDetailId | No | String | The transaction detail ID to be |
| | | | searched for. |
| ...walletTrxTypeEnum | No | Enum | The wallet transaction type to be |
| | | | searched for. One of “transaction”, |
| | | | “external”, “settlement”, “cancel”, |
| | | | “partialSettlement”, “partialCancel”, |
| | | | “auction”, “reserved”, |
| | | | “lifetimeExpired”, “chargeback”, |
| | | | “partial”, “reverse_auction” or |
| | | | “refund”. |

b. findWalletTransactionResponse

| | | | |
|---|---|---|---|
| count | Yes | Integer | The number of results returned in |
| | | | this response. |
| countTotal | Yes | Integer | The total number of results for this |
| | | | search. |
| from | Yes | Integer | The start index of the returned |
| | | | results. |
| walletTransactions | Yes | Object | The set of wallet transactions |
| | | | matching the search criteria. |
| walletTransactions.GwalletTransactionOut | Yes | Object | The wallet transaction. |
| ...GwalletTransactionOut.amount | Yes | Integer | The amount of the transaction. |
| ...GwalletTransactionOut.associatedAccountId | Yes | String | The account ID. |
| ...GwalletTransactionOut.currencyIdentifier | Yes | String | The currency ID. |
| ...GwalletTransactionOut.description | Yes | String | The transaction description. |
| ...GwalletTransactionOut.identityId | Yes | String | The Identity ID. |
| ...GwalletTransactionOut.partial | Yes | Boolean | Whether this is a partial |
| | | | transaction. |
| ...GwalletTransactionOut.transactionDetailId | Yes | String | The transaction detail ID. |
| ...GwalletTransactionOut.walletTrxTime | Yes | Date | The date of the transaction. |
| ...GwalletTransactionOut.walletTrxType | Yes | Enum | The wallet transaction type. One of |
| | | | “transaction”, “external”, |
| | | | “settlement”, “cancel”, |
| | | | “partialSettlement”, “partialCancel”, |
| | | | “auction”, “reserved”, |
| | | | “lifetimeExpired”, “chargeback”, |
| | | | “partial”, “reverse_auction” or |
| | | | “refund”. |

### Storefront Management

A storefront management module 308 may provide a number of web services as shown in FIG. 3b including functions such as item service 344 and search service 346. The item service 344 manages the catalog of items offered on the storefront for the game application 106. At a minimum, the catalog consists of item classifications, event templates, items and offers. Classifications are item types that may be defined during the client setup process, that control how content is delivered. For example, in-game content or currency purchases. Classifications are used for categorization of content in the catalog.

Event templates are configuration profiles that are used to simplify the configuration of large numbers of similar items. They can be used to specify item attributes such as whether an item is associated to an account or an identity, item multiplicity, auction bidding increments, whether an item is resellable, item availability end-date, and inventory lifetime.

Items represent digital goods that can be owned by a consumer. Digital goods can consist of more tangible goods such as a piece of equipment a character keeps in their inventory, or pure digital services such as removal of a level cap. In a preferred embodiment, all items have a classification and event template.

Offers represent an offering of an item on the storefront. Pricing and availability is defined at the offer level. Offers have a many-to-many relationship so that an offer can consist of multiple items (bundled offers) and an item can be added to any number of items.

Game attributes are a hierarchy of attributes that can be applied to an identity, item or offer in order to perform filtering in the storefront. The item service 344 methods are listed in Table 31 and described in Tables 32-34. For example, a game attribute called “Character Level” could be defined. This attribute could be populated in the Identity with the player's current level. The same attribute could be applied to items or offers in order to restrict purchasing to Identities whose level equals or exceeds the level attribute of the item or offer.

TABLE 31
Item Service Methods

| Method | Description |
|---|---|
| createEventID | Creates event templates |
| createItemTemplate | Creates items |
| createOffer | Creates an offer for an item |

TABLE 32

| | | | |
|---|---|---|---|
| Parameter | Req'd? | Type | Description |

a. createEventId

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| eventIdParams | Yes | Object | The Event Template details. |
| eventIdParams.active | Yes | Boolean | Whether the Event Template is |
| | | | active. |
| eventIdParams.autoBidIntervalCentsPerUnit | No | Integer | The automatically populated bid |
| | | | increase when placing a new bid in |
| | | | an auction. |
| eventIdParams.cooldown | No | Integer | The number of days a consumer |
| | | | must own an item before reselling |
| | | | it. |
| eventIdParams.duration | No | Integer | The relative number of days that an |
| | | | item will exist in a user's inventory. |
| eventIdParams.endDate | No | Date | An absolute date after which an |
| | | | item expires from a user's |
| | | | inventory. |
| eventIdParams.identityMandatory | Yes | Boolean | Whether an identity must be |
| | | | associated with a purchasing |
| | | | account. |
| eventIdParams.maxQuantityIdentity | No | Integer | The maximum number of item |
| | | | instances an identity may have. |
| eventIdParams.maxQuantityMember | No | Integer | The maximum number of item |
| | | | instances an account, including all |
| | | | of its identities, may have. |
| eventIdParams.name | Yes | String | The name of the event template. |
| eventIdParams.resellable | No | Boolean | Whether or not the items with this |
| | | | event template are resellable on a |
| | | | secondary market. |

b. createEventIdResponse

| | | | |
|---|---|---|---|
| return | Yes | String | The name of the event created. |

TABLE 33

| | | | |
|---|---|---|---|
| Parameter | Req'd? | Type | Description |

a. createItemTemplate

| | | | |
|---|---|---|---|
| key | Yes | Object | Encapsulates security token |
| | | | information. |
| key.accountId | No | String | The FFG account ID of the |
| | | | system account making the |
| | | | call. |
| key.ip | No | String | The IP address of the system |
| | | | making the call. |
| key.key | Yes | String | A pre-configured credential |
| | | | used to authenticate the caller. |
| key.uuid | No | String | Unique identifier of the request. |
| | | | If provided, subsequent |
| | | | requests with the same UUID |
| | | | should be ignored. |
| itemTemplateIn | Yes | Object | The Item details. |
| itemTemplateIn.accountId | Yes | String | The account ID whose catalog |
| | | | the item should be added to. |
| itemTemplateIn.amount | No | Integer | For items that have a currency |
| | | | classification, the amount of |
| | | | the currency to give the |
| | | | customer with purchase of the |
| | | | item. |
| itemTemplateIn.attributeValues | No | Object | The set of attribute values for |
| | | | the item. |
| ...attributeValues.AttributeValue | Yes | Object | An attribute value. |
| ...AttributeValue.attributeValueType | Yes | String | The attribute value type. |
| ...AttributeValue.customText | Yes | String | The value of the game attribute |
| | | | to set. |
| ...AttributeValue.inGameId | Yes | String | The In-Game ID of the game |
| | | | attribute. |
| ...AttributeValue.name | Yes | String | The key of the game attribute. |
| itemTemplateIn.attributes | No | Object | The set of value-less game |
| | | | attributes. |
| ...attributes.Attribute | Yes | Object | A value-less game attribute. |
| ...Attribute.inGameId | Yes | String | The in-game ID of the game |
| | | | attribute. |
| ...Attribute.name | Yes | String | The name of the game |
| | | | attribute. |
| itemTemplateIn.classificationIdentifier | Yes | String | The name of the classification |
| | | | to apply to the item. |
| itemTemplateIn.currencyIdentifier | No | String | For items that have a currency |
| | | | classification, the type of |
| | | | currency to give the customer |
| | | | with purchase of the item. |
| itemTemplateIn.eventIdentifier | Yes | String | The event template to apply to |
| | | | the item. |
| itemTemplateIn.fileNames | No | Object | The set of image URLs to be |
| | | | associated with the item. |
| | | | These URLs should be set to |
| | | | FFG accessible locations for |
| | | | retrieval, resizing and caching. |
| itemTemplateIn.fileNames.string | Yes | String | A file URL. |
| itemTemplateIn.gameIdentifier | Yes | String | The game ID that the item |
| | | | applies to. |
| itemTemplateIn.inGameId | Yes | String | The In-Game ID of the item. |
| itemTemplateIn.itemNumber | Yes | String | An internal identifier for the |
| | | | item. |
| itemTemplateIn.offerDescriptions | No | Object | The set of default offer |
| | | | descriptions for the item. |
| ...offerDescriptions.OfferDescription | Yes | Object | A locale specific offer |
| | | | description. |
| ...OfferDescription.description | Yes | String | The description that will be |
| | | | shown in the storefront. |
| ...OfferDescription.localeIdentifier | Yes | String | The locale the description |
| | | | should be shown for. |
| ...OfferDescription.name | Yes | String | The name that will be shown in |
| | | | the storefront. |
| itemTemplateIn.purchaseType | No | Object | The set of purchase types this |
| | | | item is eligible for. |
| itemTemplateIn.purchaseType.string | Yes | String | One of “buyNow, “auction”, |
| | | | “reservedAuction” or “coupon”. |
| itemTemplateIn.riskClassIdentifier | No | String | The maximum risk class that a |
| | | | consumer account can have to |
| | | | be eligible to purchase the |
| | | | item. |

b. createItemTemplateResponse

| | | | |
|---|---|---|---|
| return | Yes | String | The In-Game ID of the item |
| | | | created. |

TABLE 34

| | | | |
|---|---|---|---|
| Parameter | Req'd? | Type | Description |

a. createOffer

| | | | |
|---|---|---|---|
| key | Yes | Object | Encapsulates security token |
| | | | information. |
| key.accountId | No | String | The FFG account ID of the |
| | | | system account making the |
| | | | call. |
| key.ip | No | String | The IP address of the system |
| | | | making the call. |
| key.key | Yes | String | A pre-configured credential |
| | | | used to authenticate the caller. |
| key.uuid | No | String | Unique identifier of the |
| | | | request. If provided, |
| | | | subsequent requests with the |
| | | | same UUID should be ignored. |
| offerDetailsIn | Yes | Object | The offer details. |
| offerDetailsIn.accountId | Yes | String | The account ID whose catalog |
| | | | the item should be added to. |
| offerDetailsIn.amount | No | Integer | For items that have a currency |
| | | | classification, the amount of |
| | | | the currency to give the |
| | | | customer with purchase of the |
| | | | item. |
| offerDetailsIn.attributeValues | No | Object | The set of attribute values for |
| | | | the item. |
| ...attributeValues.AttributeValue | Yes | Object | An attribute value. |
| ...AttributeValue.attributeValueType | Yes | String | The attribute value type. |
| ...AttributeValue.customText | Yes | String | The value of the game |
| | | | attribute to set. |
| ...AttributeValue.inGameId | Yes | String | The In-Game ID of the game |
| | | | attribute. |
| ...AttributeValue.name | Yes | String | The key of the game attribute. |
| offerDetailsIn.attributes | No | Object | The set of value-less game |
| | | | attributes. |
| ...attributes.Attribute | Yes | Object | A value-less game attribute. |
| ...Attribute.inGameId | Yes | String | The in-game ID of the game |
| | | | attribute. |
| ...Attribute.name | Yes | String | The name of the game |
| | | | attribute. |
| offerDetailsIn.classificationIdentifier | Yes | String | The name of the classification |
| | | | to apply to the item. |
| offerDetailsIn.couponGroups | No | Object | The set of coupon groups that |
| | | | this offer is eligible for. |
| ...couponGroups.CouponGroupIn | Yes | Object | A coupon group. |
| ...CouponGroupIn.couponGroupName | Yes | String | The name of the coupon |
| | | | group. |
| offerDetailsIn.deliveryDate | No | Date | An optional fixed delivery date. |
| | | | Useful for pre-sale promotions. |
| offerDetailsIn.deliveryTimeIdentifier | No | String | The optional delivery time ID. |
| offerDetailsIn.description | Yes | String | The default offer description. |
| offerDetailsIn.endDate | No | String | An optional end date after |
| | | | which the offer should not be |
| | | | available. |
| offerDetailsIn.endDateFromStart | No | Integer | The number of hours from the |
| | | | start date that the item should |
| | | | be available. |
| offerDetailsIn.externalOfferId | No | String | An external identifier for the |
| | | | offer. |
| offerDetailsIn.gameIdentifier | Yes | String | The Game ID the offer is |
| | | | associated to. |
| offerDetailsIn.identityId | No | String | The identity ID that owns the |
| | | | item being sold. Used for |
| | | | secondary market offers. |
| offerDetailsIn.inGameId | Yes | String | The In-Game ID of the offer. |
| offerDetailsIn.itemType | Yes | String | One of “auction”, “buyNow”, |
| | | | “reverseAuction”, |
| | | | “multiplePricePoint”, “coupon”, |
| | | | or “auctionAndBuyNow”. |
| offerDetailsIn.marketType | Yes | String | One of “primary” or |
| | | | “secondary”. |
| offerDetailsIn.offerBundles | No | Object | The set of bundled items. |
| ...offerBundles.OfferBundle | Yes | Object | A bundled item. |
| ...OfferBundle.inGameId | Yes | String | The In-Game ID of the item. |
| ...OfferBundle.quantity | Yes | Integer | The quantity of the item to be |
| | | | sold. |
| offetDetailsIn.offerDescriptions | No | Object | The set of default offer |
| | | | descriptions for the item. |
| ...offerDescriptions.OfferDescription | Yes | Object | A locale specific offer |
| | | | description. |
| ...OfferDescription.description | Yes | String | The description that will be |
| | | | shown in the storefront. |
| ...OfferDescription.localeIdentifier | Yes | String | The locale the description |
| | | | should be shown for. |
| ...OfferDescription.name | Yes | String | The name that will be shown in |
| | | | the storefront. |
| offerDetailsIn.prices | Yes | Object | The set of price points for the |
| | | | offer. |
| ...prices.PricePointIn | Yes | Object | A price point. |
| ...PricePointIn.default | Yes | Boolean | Whether the price point is the |
| | | | default for the offer. |
| ...PricePointIn.externalPricePointId | No | String | An external ID for the price |
| | | | point. |
| ...PricePointIn.priceTypes | Yes | Object | The set of price types for the |
| | | | price point. |
| ...priceTypes.PriceType | Yes | Object | A price type. |
| ...PriceType.couponGroupName | No | String | The coupon group name the |
| | | | price type is eligible for. |
| ...PriceType.currencyIdentifier | Yes | String | The currency ID of the price |
| | | | type. |
| ...PriceType.price | Yes | Decimal | The price. |
| ...PriceType.priceType | Yes | Enum | One of “buyNow, “auction”, |
| | | | “reservedAuction” or “coupon”. |
| offerDetailsIn.quantity | No | String | The number of times the offer |
| | | | may be purchased. |
| | | | Either “quantity” or |
| | | | “quantityUnlimited” should be |
| | | | used. |
| offerDetailsIn.quantityUnlimited | No | Boolean | Whether the offer can be |
| | | | purchased unlimited times. |
| | | | Either “quantity” or |
| | | | “quantityUnlimited” should be |
| | | | used. |
| offerDetailsIn.reverse | No | Boolean | Whether this is a reverse |
| | | | auction. |
| offerDetailsIn.startDate | No | Date | The starting date after which |
| | | | the offer should become |
| | | | available. |
| | | | Either “startDate” or “startNow” |
| | | | should be used. |
| offerDetailsIn.startNow | No | Boolean | Whether to use the creation |
| | | | date of the offer as the start |
| | | | date. |
| | | | Either “startDate” or “startNow” |
| | | | should be used. |
| offerDetailsIn.tagStrings | No | Object | A set of keyword tags that are |
| | | | used to enhance search. |
| offerDetailsIn.tagStrings.string | Yes | String | A keyword tag. |

b. createOfferResponse

| | | | |
|---|---|---|---|
| return | Yes | String | EThe In-Game ID of the offer |
| | | | created. |

A search service 346 is used to retrieve catalog data from the in-game e-commerce platform for presentation within the game publisher's own storefront or shop, or for synchronization with an external catalog source. The search service 346 methods are listed in Table 35 and described in Tables 36-39.

TABLE 35
Search Service Methods

| Method | Description |
|---|---|
| findShop | Retrieves a listing of shops |
| findOffer | Retrieves offers matching given search parameters |
| findInventory | Retrieves inventory owned by identities identified in the |
| | in-game e-commerce platform |
| findTransaction | Retrieves storefront transactions |

TABLE 36

| | | | |
|---|---|---|---|
| Parameter | Req'd? | Type | Description |

a. findShop

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| searchParams | No | Object | General search parameters. |
| searchParams.accountId | No | String | The account ID to search within. |
| searchParams.ascending | No | Boolean | Whether the results should be |
| | | | returned in ascending alphabetical |
| | | | order. |
| searchParams.count | No | Integer | The number of results to be |
| | | | returned. Used with “from” can be |
| | | | used to implement pagination. |
| searchParams.from | No | Integer | The start position from which the |
| | | | results should be returned. Used |
| | | | with “count” can be used to |
| | | | implement pagination. |
| searchParams.gameIdentifier | No | String | The Game identifier to search |
| | | | within. |
| searchParams.identityId | No | String | The identity to search within. |
| searchParams.locale | No | String | The locale to search within. |
| searchParams.searchOrder | No | String | The search order the results should |
| | | | be returned. |
| shopSearchParams | Yes | Object | The shop search parameters. |
| shopSearchParams.accountNickname | No | String | The nickname of the account that |
| | | | owns the shop. |
| shopSearchParams.gameIdentifier | No | String | The game ID to retrieve shops for. |
| shopSearchParams.name | No | String | The name of the shop. |

b. findShopResponse

| | | | |
|---|---|---|---|
| count | Yes | Integer | The number of results returned in |
| | | | this response. |
| countTotal | Yes | Integer | The total number of results for this |
| | | | search. |
| from | Yes | Integer | The start index of the returned |
| | | | results. |
| shops | Yes | Object | The set of shops found. |
| shops.shop | Yes | Object | The shop details. |

TABLE 37

| | | | |
|---|---|---|---|
| Parameter | Req'd? | Type | Description |

a. findOffer

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| searchParams | No | Object | General search parameters. |
| searchParams.accountId | No | String | The account ID to search within. |
| searchParams.ascending | No | Boolean | Whether the results should be |
| | | | returned in ascending alphabetical |
| | | | order. |
| searchParams.count | No | Integer | The number of results to be |
| | | | returned. Used with “from” can be |
| | | | used to implement pagination. |
| searchParams.from | No | Integer | The start position from which the |
| | | | results should be returned. Used |
| | | | with “count” can be used to |
| | | | implement pagination. |
| searchParams.gameIdentifier | No | String | The Game identifier to search |
| | | | within. |
| searchParams.identityId | No | String | The identity to search within. |
| searchParams.locale | No | String | The locale to search within. |
| searchParams.searchOrder | No | String | The search order the results should |
| | | | be returned. |
| offerSearchDetails.attributeValues | No | Object | The set of attribute values for the |
| | | | offer. |
| ...attributeValues.AttributeValue | Yes | Object | An attribute value. |
| ...AttributeValue.attributeValueType | Yes | String | The attribute value type. |
| ...AttributeValue.customText | Yes | String | The value of the game attribute to |
| | | | set. |
| ...AttributeValue.inGameId | Yes | String | The In-Game ID of the game |
| | | | attribute. |
| ...AttributeValue.name | Yes | String | The key of the game attribute. |
| offerDetailsIn.attributes | No | Object | The set of value-less game |
| | | | attributes. |
| ...attributes.Attribute | Yes | Object | A value-less game attribute. |
| ...Attribute.inGameId | Yes | String | The in-game ID of the game |
| | | | attribute. |
| ...Attribute.name | Yes | String | The name of the game attribute. |
| offerSearchDetails.classificationIdentifier | No | String | The name of the classification of the |
| | | | offers to return. |
| offerSearchDetails.creatorAccountId | No | String | The account ID of the owner of the |
| | | | offer. |
| offerSearchDetails.creatorIdentityId | No | String | The identity ID of the owner of the |
| | | | offer. |
| offerSearchDetails.currencyIdentifier | No | Object | The set of currency types to retrieve. |
| ...currencyIdentifier.string | Yes | String | The currency identifier. |
| offerSearchDetails.description | No | String | The description of the offer. |
| offerSearchDetails.featured | No | Boolean | Whether the offer is featured. |
| offerSearchDetails.gameIdentifier | No | String | The Game ID of the offers to |
| | | | retrieve. |
| offerSearchDetails.marketType | No | Enum | One of “primary” or “secondary”. |
| offerSearchDetails.name | No | String | The name of the offer. |
| offerSearchDetails.offerType | No | Enum | One of “auction”, “buyNow”, |
| | | | “reverseAuction”, |
| | | | “multiplePricePoint”, “coupon”, or |
| | | | “auctionAndBuyNow”. |
| offerSearchDetails.templateInGameId | No | String | The In-Game ID of the item the offer |
| | | | includes. |

b. findOfferResponse

| | | | |
|---|---|---|---|
| count | Yes | Integer | The number of results returned in |
| | | | this response. |
| countTotal | Yes | Integer | The total number of results for this |
| | | | search. |
| from | Yes | Integer | The start index of the returned |
| | | | results. |
| offers | Yes | Object | The set of offers matching the |
| | | | search criteria. |
| offers.Offer | No | Object | The offer result. |
| ...Offer.classificationIdentifier | Yes | String | The classification name of the offer. |
| ...Offer.externalOfferId | No | String | The external offer ID. |
| ...Offer.inGameId | Yes | String | The In-Game ID of the offer. |
| ...Offer.offerBundles | No | Object | The set of bundled items. |
| ...offerBundles.OfferBundle | Yes | Object | A bundled item. |
| ...OfferBundle.inGameId | Yes | String | The In-Game ID of the item. |
| ...OfferBundle.quantity | Yes | Integer | The quantity of the item. |

TABLE 38

| | | | |
|---|---|---|---|
| Parameter | Req'd? | Type | Description |

a. findInventory

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| searchParams | No | Object | General search parameters. |
| searchParams.accountId | No | String | The account ID to search within. |
| searchParams.ascending | No | Boolean | Whether the results should be |
| | | | returned in ascending alphabetical |
| | | | order. |
| searchParams.count | No | Integer | The number of results to be |
| | | | returned. Used with “from” can be |
| | | | used to implement pagination. |
| searchParams.from | No | Integer | The start position from which the |
| | | | results should be returned. Used |
| | | | with “count” can be used to |
| | | | implement pagination. |
| searchParams.gameIdentifier | No | String | The Game identifier to search |
| | | | within. |
| searchParams.identityId | No | String | The identity to search within. |
| searchParams.locale | No | String | The locale to search within. |
| searchParams.searchOrder | No | String | The search order the results should |
| | | | be returned. |

b. findInventoryResponse

| | | | |
|---|---|---|---|
| count | Yes | Integer | The number of results returned in |
| | | | this response. |
| countTotal | Yes | Integer | The total number of results for this |
| | | | search. |
| from | Yes | Integer | The start index of the returned |
| | | | results. |
| inventoryItems | Yes | Object | The set of inventory items returned. |
| inventoryItems.InventoryItem | Yes | Object | An inventory record. |
| ...InventoryItem.accountId | Yes | String | The account ID of the user that |
| | | | owns the item. |
| ...InventoryItem.gameIdentifier | Yes | String | The Game ID of the user's identity. |
| ...InventoryItem.identityId | Yes | String | The Identity ID of the user. |
| ...InventoryItem.inGameId | Yes | String | The In-Game ID of the item owned. |
| ...InventoryItem.quantity | Yes | Integer | The quantity of the item owned by |
| | | | the user. |

TABLE 39

| | | | |
|---|---|---|---|
| Parameter | Req'd? | Type | Description |

a. findTransaction

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | Yes | String | A pre-configured credential used to |
| | | | authenticate the caller. |
| key.uuid | No | String | Unique identifier of the request. If |
| | | | provided, subsequent requests with |
| | | | the same UUID should be ignored. |
| searchParams | No | Object | General search parameters. |
| searchParams.accountId | No | String | The account ID to search within. |
| searchParams.ascending | No | Boolean | Whether the results should be |
| | | | returned in ascending alphabetical |
| | | | order. |
| searchParams.count | No | Integer | The number of results to be |
| | | | returned. Used with “from” can be |
| | | | used to implement pagination. |
| searchParams.from | No | Integer | The start position from which the |
| | | | results should be returned. Used |
| | | | with “count” can be used to |
| | | | implement pagination. |
| searchParams.gameIdentifier | No | String | The Game identifier to search |
| | | | within. |
| searchParams.identityId | No | String | The identity to search within. |
| searchParams.locale | No | String | The locale to search within. |
| searchParams.searchOrder | No | String | The search order the results should |
| | | | be returned. |
| transactionSearchParams | No | Object | The transaction search params. |
| transactionSearchParams.accountId | No | String | The account ID of the user to |
| | | | retrieve transactions for. |
| transactionSearchParams.identityId | No | String | The identity ID of the user to retrieve |
| | | | transactions for. |
| transactionSearchParams.orderNumber | No | String | The order number of the transaction |
| | | | to retrieve. |

b. findTransactionResponse

| | | | |
|---|---|---|---|
| count | Yes | Integer | The number of results returned in |
| | | | this response. |
| countTotal | Yes | Integer | The total number of results for this |
| | | | search. |
| from | Yes | Integer | The start index of the returned |
| | | | results. |
| transactions | Yes | Object | The set of transactions that match |
| | | | the search criteria. |
| transactions.Transaction | No | Object | A transaction result. |
| ...Transaction.accountId | Yes | String | The account ID. |
| ...Transaction.amountWithTax | Yes | Decimal | The price paid after tax. |
| ...Transaction.amountWithoutTax | Yes | Decimal | The price paid before tax. |
| ...Transaction.creditCardInfoId | No | String | The credit card ID used in the |
| | | | transaction. |
| ...Transaction.currencyIdentifier | Yes | String | The currency type used in the |
| | | | transaction. |
| ...Transaction.paymentDate | Yes | Date | The date of payment. |
| ...Transaction.paymentMethod | Yes | String | The method of payment. |
| ...Transaction.shippingType | No | String | The type of shipping. |
| ...Transaction.transactionDetails | Yes | Object | The set of sub-transaction details. |
| ...transactionDetails.TransactionDetail | Yes | Object | A sub-transaction. |
| ...TransactionDetail.accountId | Yes | String | The account ID. |
| ...TransactionDetail.active | Yes | String | Whether the transaction is active. |
| ...TransactionDetail.amountWithTax | Yes | Decimal | The price paid after tax. |
| ...TransactionDetail.amountWithoutTax | Yes | Decimal | The price paid before tax. |
| ...TransactionDetail.associatedAccountId | Yes | String | The associated account ID. |
| ...TransactionDetail.balances | No | Object | Not returned in findTransaction |
| | | | results. |
| ...TransactionDetail.currencyIdentifier | Yes | String | The currency used. |
| ...TransactionDetail.customerAccountId | Yes | String | The purchaser's account ID. |
| ...TransactionDetail.customerIdentityId | No | String | The purchaser's identity ID. |
| ...TransactionDetail.description | Yes | String | The description of the |
| ...TransactionDetail.gameId | Yes | String | The Game ID. |
| ...TransactionDetail.identityId | Yes | String | The identity ID. |
| ...TransactionDetail.marketType | Yes | Enum | One of “primary” or “secondary”. |
| ...TransactionDetail.merchantAccountId | Yes | String | The seller's account ID. |
| ...TransactionDetail.merchantIdentityId | No | String | The seller's identity ID. |
| ...TransactionDetail.offer | Yes | Object | The set of offers purchased in this |
| | | | transaction. |
| ...offer.classificationIdentifier | Yes | String | The classification of the offer. |
| ...offer.externalOfferId | Yes | String | The external offer ID. |
| ...offer.inGameId | Yes | String | The In-Game ID of the offer. |
| ...offer.offerBundles | Yes | Object | The set of bundled items in the offer. |
| ...offerBundles.OfferBundle | Yes | Object | The bundled item. |
| ...OfferBundle.inGameId | Yes | String | The In-Game ID of the bundled item. |
| ...OfferBundle.quantity | Yes | Integer | The quanity of the bundled item |
| | | | purchased. |
| ...TransactionDetail.orderNumber | Yes | String | The order number of the transaction. |
| ...TransactionDetail.price | Yes | String | The price paid after tax. |
| ...TransactionDetail.purchaseDate | Yes | Date | The purchase date. |
| ...TransactionDetail.quantity | Yes | Integer | The quantity purchased. |
| ...TransactionDetail.reverseAuction | Yes | Boolean | Whether this transaction was for a |
| | | | reverse auction. |
| ...TransactionDetail.transactionDetailId | Yes | String | The transaction detail ID. |
| ...TransactionDetail.transactionTime | Yes | Time | The time of the transaction. |
| ...TransactionDetail.walletTrxTypeEnum | Yes | Enum | One of “transaction”, “external”, |
| | | | “settlement”, “cancel”, |
| | | | “partialSettlement”, “partialCancel”, |
| | | | “auction”, “reserved”, |
| | | | “lifetimeExpired”, “chargeback”, |
| | | | “partial”, “reverse_auction” or |
| | | | “refund”. |

### Purchasing (Notification)

A purchasing management module 312 responds to a call made by the game application or game publisher site 106 to the in-game e-commerce system in order to receive notification of purchases made in the in-game e-commerce platform. This call is handled by a notification callback web service 348 in the purchasing management module 312 which may be one of a number of web services as shown in FIG. 3b.

Two-way authentication can be implemented using the “handshake” method of the interface to retrieve an appropriate security key from the publisher's system in real time. The notification callback service 348 methods are listed in Table 40 and described in Tables 41-43.

TABLE 40
Notification Callback Web Service Methods

| Method | Description |
|---|---|
| onDelivery | Called each time a purchase is successfully |
| | completed in the in-game e-commerce |
| | platform. Provides transaction detail for the |
| | game publisher to use as it desires |
| checkNotificationService | Used by the in-game e-commerce platform to |
| | test for the status of the game publisher's |
| | environment |
| handshake | Retrieves security token details from game |
| | publisher's platform for other notification |
| | methods. May be disabled in favor of a |
| | statically configured security key in order |
| | to improve performance |

TABLE 41

| | | | |
|---|---|---|---|
| Parameter | Req'd? | Type | Description |

a. onDelivery

| | | | |
|---|---|---|---|
| key | Yes | Object | Encapsulates security token information. |
| key.accountId | No | String | The FFG account ID of the system |
| | | | account making the call. |
| key.ip | No | String | The IP address of the system making the |
| | | | call. |
| key.key | No | String | A pre-configured credential used to |
| | | | authenticate the caller. |
| key.uuid | No | String | Unique identifier of the request. If |
| | | | provided, subsequent requests with the |
| | | | same UUID should be ignored. |
| deliverable | Yes | Object | Encapsulates the details for a purchase |
| | | | transaction. |
| deliverable.active | Yes | Boolean | Whether or not the transaction is |
| | | | currently active. |
| deliverable.amountWithTax | Yes | Float | The price, including tax, paid by the |
| | | | consumer. |
| deliverable.amountWithoutTax | Yes | Float | The price, before tax, paid by the |
| | | | consumer. |
| deliverable.currencyIdentifier | Yes | String | The identifier of the currency used to |
| | | | complete the purchase. The valid values |
| | | | passed are per configuration for your |
| | | | system. |
| deliverable.customerAccountID | Yes | String | The FFG internal ID of the account that |
| | | | completed the purchase. |
| deliverable.customerIdentityID | Yes | String | The FFG internal ID of the account |
| | | | identity used to complete the purchase. |
| deliverable.gameId | Yes | String | The Game ID for which the purchase |
| | | | was made. Valid values are per |
| | | | configuration for your system. |
| deliverable.marketType | Yes | Enum | The virtual market the purchase was |
| | | | made in. |
| | | | “primary” or “secondary” |
| deliverable.merchantAccountId | Yes | String | The FFG internal ID of the account that |
| | | | was the merchant for this transaction. |
| deliverable.merchantIdentityId | Yes | String | The FFG internal ID of the account |
| | | | identity that was the merchant for this |
| | | | transaction. |
| deliverable.offer | Yes | Object | Encapsulates the order details for the |
| | | | transaction. |
| deliverable.offer.externalOfferID | No | String | The external offer ID. |
| deliverable.offer.inGameId | Yes | String | The in-game ID of the offer or bundle. |
| deliverable.offer.offerBundles | 0 or | OfferBundle | Encapsulates the offers that are part of a |
| | More | | bundle. |
| deliverable.offer.offerBundles. | Yes | Object | Encapsulates an offer that is part of a |
| OfferBundle | | | bundle. |
| ...OfferBundle.inGameId | Yes | String | The in-game ID of the offer. |
| ...OfferBundle.quantity | Yes | Int | The quanitity of the offer inside the |
| | | | bundle. |
| deliverable.orderNumber | Yes | String | The order number of the transaction. |
| deliverable.price | Yes | Float | The unit price paid by the consumer. |
| deliverable.purchaseDate | Yes | Date | The date the purchase was completed |
| deliverable.quantity | Yes | Int | The quantity of the item purchased. |
| deliverable.reverseAuction | Yes | Boolean | Whether the purchase was from a |
| | | | reverse auction. |
| deliverable.transactionDetailId | Yes | String | The FFG internal transaction detail ID of |
| | | | the purchase. |
| deliverable.walletTrxTypeEnum | Yes | Enum | The wallet transaction type. |
| | | | “transaction”, “external”, “settlement”, |
| | | | “cancel”, “partialSettlement”, |
| | | | “partialCancel”, “auction”, “reserved”, |
| | | | “lifetimeExpired”, “chargeback”, “partial”, |
| | | | or “reverse_auction”. |

b. onDeliveryResponse

| | | | |
|---|---|---|---|
| N/A | N/A | N/A | An empty response may be returned |

TABLE 42

| | | | |
|---|---|---|---|
| Parameter | Req'd? | Type | Description |

a. checkNotificationService

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system |
| | | | making the call. |
| key.key | No | String | A pre-configured credential used to |
| | | | authenticate the FFG System. |
| key.uuid | No | String | Unique identifier of the request. If |
| | | | provided, subsequent requests with |
| | | | the same UUID should be ignored. |

b. checkNotificationService Response

| | | | |
|---|---|---|---|
| N/A | N/A | N/A | An empty response may be returned |

TABLE 43

| | | | |
|---|---|---|---|
| Parameter | Req'd? | Type | Description |

a. handshake

| | | | |
|---|---|---|---|
| key | Yes | Object | Encapsulates security token |
| | | | information. |
| key.accountId | No | String | The FFG account ID of the system |
| | | | account making the call. |
| key.ip | No | String | The IP address of the system making |
| | | | the call. |
| key.key | No | String | A pre-configured credential used to |
| | | | authenticate the caller. |
| key.uuid | No | String | Unique identifier of the request. If |
| | | | provided, subsequent requests with the |
| | | | same UUID should be ignored. |
| handshakeParams | Yes | Object | Encapsulates handshake input |
| | | | parameters. |
| handshakeParams.accountId | No | String | Your system's ID of the account to be |
| | | | authenticated. |
| handshakeParams.name | No | String | The name of the account in your |
| | | | system. |
| handshakeParams.sessionId | No | String | The identifier for the user's session. |

b. handshakeResponse

| | | | |
|---|---|---|---|
| return | Yes | Object | |
| return.accountId | No | String | Echoes the account ID provided |
| | | | in the request. |
| return.name | No | String | Echoes the name provided in the |
| | | | request. |
| return.token | Yes | String | The token to be used for other |
| | | | calls in this web service. |

### Internal APIs

Internal APIs communicate data among modules. Following is a list in Table 44 of internal APIs used in a preferred embodiment of an in application commerce system and method.

TABLE 44
Internal APIs

| API | Purpose |
|---|---|
| AccountServiceInternal | Create, Read, Update and Delete account service |
| | details |
| BaseClientConfigServiceInternal | Get the configuration for a certain client |
| BasketServiceInternal | Service for an article added to a basket |
| BatchServiceInternal | This service gets the status or starts a batch run. |
| BulkUploadServiceInternal | Bulk Upload of article inventory and offer |
| | management. |
| CipherServiceInternal | For security encapsuling (SHA1) |
| ClientCreatorServiceInternal | Create configuration of client (currencies, payment |
| | forms, etc.) |
| CloudServiceInternal | Calculate content for cloud (web 2.0) shop UI |
| ComponentServiceInternal | Retrieve information about shop layout (panels, |
| | pages) |
| CountryTaxClassificationServiceInternal | Retrieve correct tax calculation for transaction |
| CouponServiceInternal | Generates coupons |
| CurrencyRateClientInternal | Retrieve exchanges rates for multiple currencies |
| CurrencyServiceInternal | Retrieve and manage the list of supported |
| | currencies per client. |
| DemographicServiceInternal | Calculate demographical profile of users. |
| DisputeServiceInternal | Create, Read, Update and Delete dispute request |
| ExchangeRateServiceInternal | Define exchange rates among multiple virtual |
| | currencies |
| FraudDataProviderInternal | Retrieve fraud data from payment partner |
| FraudDetectionServiceInternal | Service to calculate fraud scoring for all users |
| FraudServiceInternal | Manages fraud for all users |
| WalletServiceInternal | Load, reserve, debit and refund virtual currencies |
| | per wallet. |
| ICreditCardPaymentProvider | Execute credit card payments |
| ICurrency | Currency object |
| IFatfoogooFeeService | Get fatfoogoo revenue fees based on client |
| | configuration |
| InventoryServiceInternal | Manage the shop inventory |
| IPaymentCallback | Enable refunds |
| ItemBasketServiceInternal | Manage items within basket |
| ItemServiceInternal | Create, Read, Update and Delete pricepoints for |
| | items. |
| LinkCreatorInternal | Batch and wicket creator for links |
| LinkServiceInternal | Wicket links |
| MailServiceInternal | Send out external messages |
| MessageServiceInternal | Send and receive internal messages |
| NotificationRetryServiceInternal | Retry notification calls towards client if first failed |
| PaymentFormServiceInternal | Retrieve all payment option for transaction and user |
| PaymentProvider | Interface with all payment partners |
| PaymentServiceInternal | Fetch valid payment provider for payment form |
| PayoutTransactionServiceInternal | Calculate payouts per client |
| PendingPaymentServiceInternal | Manages pending payment statuses (from Paypal) |
| PostPurchaseServiceInternal | Manage all post payment related processes |
| PricePointServiceInternal | Get correct price point per offer |
| ReminderServiceInternal | Remind merchants of secondary market to deliver |
| | articles. |
| SessionServiceInternal | Retrieve and validate sessions |
| SiteServiceInternal | All information about a single shop webpage within |
| | the commerce system |
| SiteSessionInfoServiceInternal | Retrieve information about clickpath |
| SubscriptionServiceInternal | Manage subscriptions |
| TaxServiceProviderInternal | Retrieve taxation schedule |
| TicketServiceInternal | Manage customer care tickets |
| TransactionHistoryServiceInternal | Retrieve and check transaction histories |

### Example—Content Purchase

Jane is playing a fictional game called Quest, which is integrated with an in-game e-commerce system. Jane wants to purchase a sword for her Quest character. She visits the Quest website and selects the sword she wants. She has sufficient wallet balance, so the Quest system immediately calls the purchaseOffer method on the in-game e-commerce system platform (see sample XML request in Table 45). Upon successful completion of the purchase, the in-game e-commerce system generates a web service call (see sample in Table 46) to the Quest servers to notify them of the transaction using a manually configured security key.

TABLE 45
Content Purchase Method Calls
Sample XML Request

```
<soapenv:Envelope xmlns:soapenv=“http://schemas.xmlsoap.org/soap/
envelope/”
xmlns:api=“http://api.service.fatfoogoo.com/”
xmlns:bean=“http://bean.service.fatfoogoo.com”>
  <soapenv:Header/>
  <soapenv:Body>
    <api:onDelivery>
      <key>
        <bean:key>123some!key</bean:key>
      </key>
      <deliverable>
        <bean:active>true</bean:active>
        <bean:amountWithTax>50</bean:amountWithTax>
        <bean:amountWithoutTax>50</bean:amountWithoutTax>
        <bean:currencyIdentifier>GOLD</bean:currencyIdentifier>
        <bean:customerAccountId>1234</bean:customerAccountId>
        <bean:customerIdentityId>3456</bean:customerIdentityId>
        <bean:gameId>game.quest</bean:gameId>
        <bean:marketType>primary</bean:marketType>
        <bean:merchantAccountId>4567</bean:merchantAccountId>
        <bean:merchantIdentityId>5678</bean:merchantIdentityId>
        <bean:offer>
          <bean:externalOfferId>7890</bean:externalOfferId>
          <bean:inGameId>sword</bean:inGameId>
        </bean:offer>
        <bean:orderNumber>9876</bean:orderNumber>
        <bean:price>50</bean:price>
        <bean:purchaseDate>2001-10-26T21:32:52</
        bean:purchaseDate>
        <bean:quantity>1</bean:quantity>
        <bean:reverseAuction>false</bean:reverseAuction>
        <bean:transactionDetailId>7654</bean:transactionDetailId>
        <bean:walletTrxTypeEnum>transaction</
        bean:walletTrxTypeEnum>
      </deliverable>
    </api:onDelivery>
  </soapenv:Body>
</soapenv:Envelope>
```

TABLE 46
Account Service WSDL
Sample Web Service Call

```
<?xml version=“1.0” encoding=“UTF-8”?>
<wsdl:definitions name=“AccountService” targetNamespace=
“com.fatfoogoo.webservice”
xmlns:ns1=“http://api.service.fatfoogoo.com/”
xmlns:ns2=“http://cxf.apache.org/bindings/xformat”
xmlns:soap=“http://schemas.xmlsoap.org/wsdl/soap/”
xmlns:tns=“com.fatfoogoo.webservice” xmlns:wsdl=
“http://schemas.xmlsoap.org/wsdl/”
xmlns:xsd=“http://www.w3.org/2001/XMLSchema”>
  <wsdl:import
location=“https://riot.alpha.fatfoogoo.com/global/services/
AccountService?wsdl=AccountService.wsdl”
namespace=“http://api.service.fatfoogoo.com/”>
    </wsdl:import>
  <wsdl:binding name=“AccountServiceSoapBinding” type=
  “ns1:AccountService”>
    <soap:binding style=“document” transport=
    “http://schemas.xmlsoap.org/soap/http”/>
    <wsdl:operation name=“ping”>
      <soap:operation soapAction=“” style=“document”/>
      <wsdl:input name=“ping”>
        <soap:body use=“literal”/>
      </wsdl:input>
      <wsdl:output name=“pingResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
<wsdl:operation name=“getAccountDetails”>
      <soap:operation soapAction=“” style=“document”/>
      <wsdl:input name=“getAccountDetails”>
        <soap:body use=“literal”/>
      </wsdl:input>
      <wsdl:output name=“getAccountDetailsResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“setPaypalAccount”>
      <soap:operation soapAction=“” style=“document”/>
      <wsdl:input name=“setPaypalAccount”>
        <soap:body use=“literal”/>
      </wsdl:input>
      <wsdl:output name=“setPaypalAccountResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“login”>
      <soap:operation soapAction=“” style=“document”/>
      <wsdl:input name=“login”>
        <soap:body use=“literal”/>
      </wsdl:input>
      <wsdl:output name=“loginResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“authenticateSession”>
      <soap:operation soapAction=“” style=“document”/>
      <wsdl:input name=“authenticateSession”>
        <soap:body use=“literal”/>
      </wsdl:input>
      <wsdl:output name=“authenticateSessionResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“getCustomDataDetails”>
      <soap:operation soapAction=“” style=“document”/>
      <wsdl:input name=“getCustomDataDetails”>
        <soap:body use=“literal”/>
      </wsdl:input>
      <wsdl:output name=“getCustomDataDetailsResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“updateIdentity”>
      <soap:operation soapAction=“” style=“document”/>
      <wsdl:input name=“updateIdentity”>
        <soap:body use=“literal”/>
      </wsdl:input>
      <wsdl:output name=“updateIdentityResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“modifyAddressDetails”>
      <soap:operation soapAction=“” style=“document”/>
      <wsdl:input name=“modifyAddressDetails”>
        <soap:body use=“literal”/>
      </wsdl:input>
      <wsdl:output name=“modifyAddressDetailsResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“createAccount”>
      <soap:operation soapAction=“” style=“document”/>
      <wsdl:input name=“createAccount”>
        <soap:body use=“literal”/>
      </wsdl:input>
      <wsdl:output name=“createAccountResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“createMerchantAccount”>
      <soap:operation soapAction=“” style=“document”/>
      <wsdl:input name=“createMerchantAccount”>
        <soap:body use=“literal”/>
      </wsdl:input>
      <wsdl:output name=“createMerchantAccountResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“modifyCustomDataDetails”>
      <soap:operation soapAction=“” style=“document”/>
      <wsdl:input name=“modifyCustomDataDetails”>
        <soap:body use=“literal”/>
      </wsdl:input>
      <wsdl:output name=“modifyCustomDataDetailsResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“getIdentity”>
      <soap:operation soapAction=“” style=“document”/>
      <wsdl:input name=“getIdentity”>
        <soap:body use=“literal”/>
      </wsdl:input>
      <wsdl:output name=“getIdentityResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“logout”>
      <soap:operation soapAction=“” style=“document”/>
      <wsdl:input name=“logout”>
        <soap:body use=“literal”/>
      </wsdl:input>
      <wsdl:output name=“logoutResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“deleteIdentity”>
      <soap:operation soapAction=“” style=“document”/>
      <wsdl:input name=“deleteIdentity”>
        <soap:body use=“literal”/>
      </wsdl:input>
      <wsdl:output name=“deleteIdentityResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“verifyPaypal”>
      <soap:operation soapAction=“” style=“document”/>
      <wsdl:input name=“verifyPaypal”>
        <soap:body use=“literal”/>
      </wsdl:input>
      <wsdl:output name=“verifyPaypalResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“createIdentity”>
      <soap:operation soapAction=“” style=“document”/>
      <wsdl:input name=“createIdentity”>
        <soap:body use=“literal”/>
      </wsdl:input>
      <wsdl:output name=“createIdentityResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“findAccount”>
      <soap:operation soapAction=“” style=“document”/>
      <wsdl:input name=“findAccount”>
        <soap:body use=“literal”/>
      </wsdl:input>
      <wsdl:output name=“findAccountResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“reactivateAccount”>
      <soap:operation soapAction=“” style=“document”/>
      <wsdl:input name=“reactivateAccount”>
        <soap:body use=“literal”/>
      </wsdl:input>
      <wsdl:output name=“reactivateAccountResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“deleteAccount”>
      <soap:operation soapAction=“” style=“document”/>
      <wsdl:input name=“deleteAccount”>
        <soap:body use=“literal”/>
      </wsdl:input>
      <wsdl:output name=“deleteAccountResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“getIdentities”>
      <soap:operation soapAction=“” style=“document”/>
      <wsdl:input name=“getIdentities”>
        <soap:body use=“literal”/>
      </wsdl:input>
      <wsdl:output name=“getIdentitiesResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“findIdentity”>
      <soap:operation soapAction=“” style=“document”/>
      <wsdl:input name=“findIdentity”>
        <soap:body use=“literal”/>
      </wsdl:input>
      <wsdl:output name=“findIdentityResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“getMerchantDataDetails”>
      <soap:operation soapAction=“” style=“document”/>
      <wsdl:input name=“getMerchantDataDetails”>
        <soap:body use=“literal”/>
      </wsdl:input>
      <wsdl:output name=“getMerchantDataDetailsResponse”>
        <soap:body use=“literal”/>
      </wsdl:output>
    </wsdl:operation>
    <wsdl:operation name=“downgradeMerchant”>
      <soap:operation soapAction=“” style=“document”/>
      <wsdl:input name=“downgradeMerchant”>
        <soap:body use=“literal”/>
      </wsdl:input>
      <wsdl:output name=“downgradeMerchantResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“getAddressDetails”>
      <soap:operation soapAction=“” style=“document”/>
      <wsdl:input name=“getAddressDetails”>
        <soap:body use=“literal”/>
      </wsdl:input>
      <wsdl:output name=“getAddressDetailsResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“confirmMember”>
      <soap:operation soapAction=“” style=“document”/>
      <wsdl:input name=“confirmMember”>
        <soap:body use=“literal”/>
      </wsdl:input>
      <wsdl:output name=“confirmMemberResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“modifyMerchantData”>
      <soap:operation soapAction=“” style=“document”/>
      <wsdl:input name=“modifyMerchantData”>
        <soap:body use=“literal”/>
      </wsdl:input>
      <wsdl:output name=“modifyMerchantDataResponse”>
        <soap:body use=“literal”/>
      </wsdl:output>
    </wsdl:operation>
    <wsdl:operation name=“handshake”>
      <soap:operation soapAction=“” style=“document”/>
      <wsdl:input name=“handshake”>
        <soap:body use=“literal”/>
      </wsdl:input>
      <wsdl:output name=“handshakeResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“modifyAccount”>
      <soap:operation soapAction=“” style=“document”/>
      <wsdl:input name=“modifyAccount”>
        <soap:body use=“literal”/>
      </wsdl:input>
      <wsdl:output name=“modifyAccountResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“getSubscriptionDetails”>
      <soap:operation soapAction=“” style=“document”/>
      <wsdl:input name=“getSubscriptionDetails”>
        <soap:body use=“literal”/>
      </wsdl:input>
      <wsdl:output name=“getSubscriptionDetailsResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
    <wsdl:operation name=“upgradeMerchant”>
      <soap:operation soapAction=“” style=“document”/>
      <wsdl:input name=“upgradeMerchant”>
        <soap:body use=“literal”/>
      </wsdl:input>
      <wsdl:output name=“upgradeMerchantResponse”>
        <soap:body use=“literal”/>
      </wsdl:output>
      <wsdl:fault name=“ServiceException”>
        <soap:fault name=“ServiceException” use=“literal”/>
      </wsdl:fault>
    </wsdl:operation>
  </wsdl:binding>
  <wsdl:service name=“AccountService”>
    <wsdl:port binding=“tns:AccountServiceSoapBinding”
    name=“AccountServiceImplPort”>
      <soap:address
location=“https://riot.alpha.fatfoogoo.com/global/services/
AccountService”/>
    </wsdl:port>
  </wsdl:service>
</wsdl:definitions>
```

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular functions of each module may vary depending on the particular game publisher's system and requirements while maintaining substantially the same functionality and without departing from the scope and spirit of the present invention.

What is claimed is:

1. A modularized in-game e-commerce system operatively coupled through a network to a game application, the e-commerce system comprising a server with a processor and a memory, the e-commerce system further comprising:
an account management module containing program code which when executed by the processor in the server causes the server to perform operations of:
an account service that manages user profiles and accounts, each user account comprises a wallet and an account identity within the game application;
an inventory service that manages items owned by an account identity for each user account;
a wallet service that manages a balance with the wallet for each user account; and
a storefront management module containing program code which when executed by the processor in the server causes the server to perform operations of:
an item service that manages a catalog of items offered in a storefront within the game application; and
a search service that retrieves data from the catalog for presentation within the game application storefront.

2. The modularized in-game e-commerce system of claim 1 further comprising a purchasing management module containing program code which when executed by the processor in the server causes the server to perform operations of a notification callback service that responds to a call made by the game application to the e-commerce system in order to receive notification of purchases made in the e-commerce system.

3. The modularized in-game e-commerce system of claim 2 wherein the notification callback service comprises an on delivery method of interfacing with the game application to provide transaction detail for a purchase to the game application.

4. The modularized in-game e-commerce system of claim 3 wherein the notification callback service comprises a two-way authentication handshake method of interfacing with the game application to retrieve a security key and wherein the on delivery method utilized the security key when providing transaction details for the purchase to the game application.

5. The modularized in-game e-commerce system of claim 1 wherein the item service comprises a method selected from a list of:
a create event method that creates event templates for the catalog:
a create item method that creates an item for the catalog; and
a create offer method that creates an offer for an item in the catalog.

6. The modularized in-game e-commerce system of claim 1 wherein the search service comprises a method selected from a list of:
a find shop method that retrieves a listing of storefronts offered through the game application;
a find offer method that retrieves an offer matching given search parameters from a storefront offered through the game application;
a find inventory method that retrieves inventory owned by the account identity identified by the e-commerce system; and
a find transaction method that retrieves a storefront transaction from the e-commerce system.

7. The modularized in-game e-commerce system of claim 1 wherein the account service comprises a create account method that creates a user account and returns an account identification.

8. The modularized in-game e-commerce system of claim 1 wherein the account service comprises a modify account method that modifies the user account with provided details.

9. The modularized in-game e-commerce system of claim 1 wherein the wallet service comprises a credit wallet method that adds balance to the wallet for the user account.

10. The modularized in-game e-commerce system of claim 1 wherein the wallet service comprises a credit wallets method that performs batch wallet credits.

11. The modularized in-game e-commerce system of claim 1 wherein the user account comprises a second account identity within the game application and wherein the wallet is shared with both account identities.

12. An in-game e-commerce method performed by a server coupled through a network to a game application, the method comprising steps of:
managing user profiles and accounts stored in a memory on the server through an account management module, each user account comprising a wallet and an account identity within the game application;
managing items owned by an account identity through an inventory service in the account management module;
managing a balance with the wallet for each user through a wallet service in the account management module;
managing a catalog of items offered in a storefront within the game application through an item service in a storefront management module; and
retrieving data from the catalog for presentation within the game application storefront through a search service in a storefront management module.
